(19) United States
(12) Patent Application Publication
(10) Pub. No.: US 2022/0362767 A1
(43) Pub. Date: Nov. 17, 2022

(54) SYSTEMS AND METHODS FOR MEASURING COLORIMETRIC REACTIONS

(71) Applicant: Fabrico Technology, Inc., Georgetown, TX (US)

(72) Inventors: Alex Kashkin, Cambridge, MA (US); Joseph Oleniczak, Austin, TX (US); Robert Chin, Austin, TX (US)

(21) Appl. No.: 17/771,771

(22) PCT Filed: Oct. 25, 2020
(86) PCT No.: PCT/US20/57261

§ 371 Date: Apr. 25, 2022

Related U.S. Application Data
(60) Provisional application No. 62/926,421, filed on Oct. 25, 2019.
(60) Provisional application No. 62/931,334, filed on Nov. 6, 2019.
(60) Provisional application No. 62/965,951, filed on Jan. 26, 2020.

(51) Int. Cl. B01L 3/00; G01J 3/51

(52) U.S. Cl. CPC B01L 3/502715; G01J 3/51; B01L 2200/0684; B01L 2200/16; B01L 2300/0832

(57) ABSTRACT

A system includes a cartridge and an instrument. The cartridge includes a cartridge body defining an input port aligned with a central axis of the cartridge body, a plurality of channels in fluidic communication with the input port and extending radially to a plurality of reaction chamber connectors, a plurality of reaction chambers disposed at a radial distance from the central axis of the cartridge body and distributed at angles relative to the others of the plurality of reaction chambers. The system further includes an instrument including an incubation block configured to receive the plurality of reaction chambers; a motor and socket to connect with the cartridge; an illumination source having an illumination pathway; and a camera disposed in a signal pathway intersecting the illumination pathway.

### CROSS-REFERENCE TO RELATED APPLICATION(S)

This application claims benefit of U.S. Provisional Application No. 62/926,421, filed Oct. 25, 2019, U.S. Provisional Application No. 62/931,334, filed Nov. 6, 2019, and U.S. Provisional Application No. 62/965,951, filed Jan. 26, 2020, each of which is incorporated herein by reference in its entirety.

### GOVERNMENT LICENSE RIGHTS

This invention was made with government support under Contract Nos. W81XWH-17-C-0110, W81XWH-18-C-0147, and W81XWH-20-P-0037 awarded by the Department of Defense, and Contract No. NSF-RAPID: 2027169 awarded by the National Science Foundation. The government has certain rights in the invention.

### BACKGROUND

Various areas of research and medicine have shown increasing interest in quick and effective analytical techniques, particularly in the area of genetic diagnostics, e.g., the detection and identification of genetic biomarkers. Genetic diagnostic biomarkers have applications in food safety, environmental monitoring, and medical diagnostics, among other fields.

With regards to diagnostic biomarkers employed in both medical and non-medical applications, the interest in user-friendly systems and devices having high precision, specificity, and accuracy has yet to be achieved in a cost-effective manner Clear instances of such difficulties include quantitative polymerase chain reaction (qPCR) machines and devices used for nucleic acid amplification reactions, which are cumbersome to work with, and yet are sought after for sensitive, specific, and highly accurate -genetic diagnostics.

Conventional qPCR instruments employ thermal cycling, raising and lowering temperatures to facilitate enzymatic replication of nucleic acid sequences. During the amplification, qPCR instruments record color signals from individual reactions, which are used by skilled users to analyze, determine, and interpret the final results.

While such qPCR instruments are industry standard, their operation presents a number of inefficacies, including the use of complicated and labor-intensive sample preparation, user training for device operation, and subsequent data analysis, leading to high costs of consumables and time-prohibitive operational constraints.

Such inefficacies became a true detriment during the recent COVID-19 pandemic, when PCR testing kits were the primary means of detecting infection. Many types of testing kits were found to provide inaccurate results stemming from sample collection and preparation errors. Further, many testing facilities were slow to provide results based on limited availability of skilled labor, long instrument run times, and the availability of consumables.

With the above challenges in mind, an affordable, easy-to-use system would be desirable for analytical biomarker identification, detection of nucleic acids, and diagnostic applications.

### BRIEF DESCRIPTION OF THE DRAWINGS

The present disclosure may be better understood, and its numerous features and advantages made apparent to those skilled in the art by referencing the accompanying drawings.

FIG. 1, FIG. 2, and FIG. 3 include illustrations of an example instrument.

FIG. 4, FIG. 5, FIG. 6, FIG. 7, FIG. 8, FIG. 9, and FIG. 10 include illustrations of an example cartridge.

FIG. 11, FIG. 12, FIG. 13, FIG. 14, FIG. 15, and FIG. 16 include illustrations of an example measurement module.

FIG. 17 and FIG. 18 include illustrations of an alternative example of a measurement module.

FIG. 19 includes a cross-section of an example incubation block.

FIG. 20 includes an illustration of example components of an example instrument.

FIG. 21 includes an illustration of subsystems within an instrument.

FIG. 22 includes a block flow diagram of an example method for performing measurement on an example instrument.

FIG. 23 includes a block flow diagram of an example method for calibrating an instrument.

FIG. 24 includes a block flow diagram illustrating an example method for performing a measurement.

FIG. 25 includes a block flow diagram illustrating an example method for training a neural network.

FIG. 26 includes a block flow diagram illustrating an example method for external communication with an example instrument.

FIG. 27 includes an illustration of an example seal.

FIG. 28 includes a block flow diagram illustrating an example method for analyzing images.

FIG. 29 includes an illustration of example sample images.

FIG. 30 includes an illustration of plotted data collected by an instrument.

FIG. 31 includes an illustration of processed data collected by an instrument.

FIG. 32 and FIG. 33 include illustrations of an example instrument.

FIG. 34 includes an illustration of an example heated lid for the example instrument.

FIG. 35 includes an illustration of an example cartridge.

FIG. 36 includes an illustration of an example injector of the example cartridge of FIG. 35.

FIG. 37, FIG. 38, and FIG. 39 include illustrations of another example cartridge.

FIG. 40 includes an illustration of the example cartridge disposed in a heat plate.

FIG. 41 includes an exploded view illustration of an example measurement module.

FIG. 42 include an exploded view illustration of an example detection system.

FIG. 43 includes an exploded view illustration of a portion of the example measurement module.

FIG. 44 includes an exploded view illustration of the example measurement module.

FIG. 45 includes a diagram illustrating a method of controlling temperatures.

FIG. 46 includes a diagram illustrating a method of processing images.

FIG. 47 includes a diagram illustrating instrument functions.

FIG. 48 includes a diagram illustrating software architecture.

FIG. 49 includes graphs illustrating temperature profiles.

The use of the same reference symbols in different drawings indicates similar or identical items.

### DETAILED DESCRIPTION

In an embodiment, an instrument is configured to receive a cartridge that includes a plurality of reaction chambers. The instrument can measure progress or completion of a reaction within a reaction chamber using an illumination source and an imaging device, such as a camera, photodiode, photomultiplier tube, or Photodiode Array Detector (PDA). Reagents within the reaction chamber can include indicators that change colorimetrically or fluoresce in response to progression of the reaction and an excitation light source. The imaging device can detect a color change or fluorescence, for example, enabling detection and optionally, quantification of genetic biomarkers.

In a further embodiment, a user can inject a sample into the cartridge. The sample is distributed into the plurality of reaction chambers. Lyophilized or dried reagents within the plurality of reaction chambers can react, for example, in response to changes in temperature, providing color or fluorescent signals. The instrument can measure the color or fluorescent signals by providing an illumination source, such as a light source, and imaging the resulting color or fluorescence. For example, the instrument can include an imaging device, such as a camera, to collect images. Image processing can be utilized to provide a result. Depending upon the nature of the test, the result can be detection of genetic biomarkers or quantification of such genetic biomarkers.

In a particular embodiment, an instrument capable of conducting isothermal chemical reactions collects photographic signals and images based on color and analyzes the collected photographic signals and images. The chemical reactions take place in an inserted cartridge containing chambers for said reactions. The cartridge can be incubated at desired temperatures and rotated such that the chambers are individually photographed by a camera with a light filter or other imaging device. The photographs constitute signals and images, which can be analyzed by the instrument using a neural network and other image processing techniques, giving output results of the reaction. Operation of the instrument may be facilitated through a graphical user interface, along with remote access of collected data.

The COVID-19 pandemic demonstrated a lack of versatile genetic testing equipment conventionally available in the market, especially that which could detect SARS-COV-2 through nucleic acid amplification assays. This lack extends to the diagnosis of other diseases, especially in low-resource and remote areas. Many conventional instruments are difficult to use by untrained users, with protocols frequently involving the manipulation of small objects and analysis of data. Consequently, many communities are not able to afford such equipment and the personnel needed for operating it. A system which executes and analyzes nucleic acid amplification reactions while being simple to use, portable, and low-cost is desirable.

Embodiment of the systems and methods described herein is useful for the detection of SARS-COV-2 in screening efforts and is being developed for distribution to low-resource areas for aiding diagnosis of diseases. The instrument can be used to execute assays for the detection of Chlamydia, Gonorrhea, E. Coli, Coliforms, and genetic mutations. The system can be correctly used by those without prior training Componentry has been chosen to reduce material costs, with intent to improve the accessibility of genetic testing technology.

As widely evident during the recent pandemic, ongoing difficulties inherent in rolling out comparable high technical need, lab-based qPCR assays has caused significant setback to thwarting viral spread. Embodiments of the present technology are an alternative test platform consciously designed to be inexpensive and easy to use with minimal technical expertise and infrastructure. This technology platform has also been thoroughly vetted for the detection of multiple pathogens including E. Coli, coliforms, Chlamydia, and Gonorrhea.

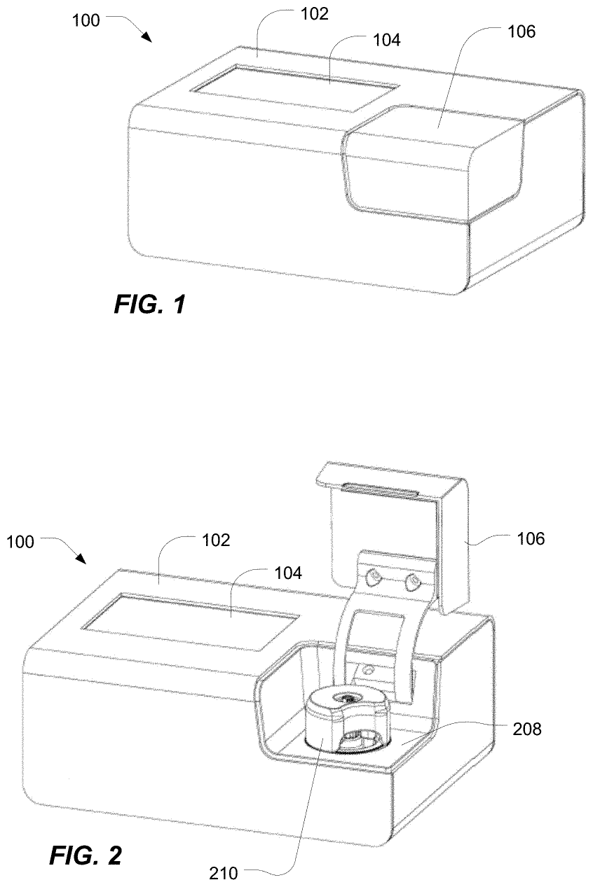

In an embodiment illustrated in FIG. 1, FIG. 2, and FIG. 3, an instrument 100 includes an outer casing 102 and a cover 106. The instrument 100 can further include a user interface 104, such as a touchscreen. Alternatively, the user interface can be implemented using keys, buttons, touchpads, a mouse, a trackball, or various display devices, among others, or any combination thereof. Optionally, the instrument 100 can interact with a user through speakers or microphones. For example, the instrument 100 can indicate completion of the task using a sound generated by a speaker.

The cover 106 can be moved between an open position and a closed position. In the closed position illustrated in FIG. 1, the cover can limit external light from impinging upon the cartridge and imaging devices. When the cover 106 is in the open position, as illustrated in FIG. 2 and FIG. 3, an instrument deck 208 is accessible. The instrument deck 208 is configured to receive a cartridge 210. In the illustrated example, the cartridge 210 has a cylindrical configuration. Alternatively, the cartridge 210 can have square, rectangular, polygon, or other shaped cross-sections.

As illustrated in FIG. 3, the cartridge 210 includes a plurality of reaction chambers 312, such as microtubes. In an example, the reaction chambers 312 are transparent, particularly in the visible spectrum. Alternatively, the reaction chambers 312 can be opaque in the visible spectrum and transparent in other spectral regions, such as but not limited to ultraviolet, infrared, or near IR spectral regions.

In an embodiment, a cartridge includes a body with a plurality of interior channels for liquid distribution. The channels lead to reaction chambers which can contain chemical reagents. The reaction chambers can be separate components, within which reagents are deposited prior to assembly of the cartridge. In an example, the reaction chambers are transparent microtubes with lyophilized reagents deposited therein. The reaction chambers can contain different reagents, allowing for customization of the cartridge and the associated analytical information that may be obtained through execution of the desired chemical reactions. In an example, fluorescent products of such reactions may indicate the presence of waterborne bacteria such as E. Coli or Coliforms. In other example, the reaction chambers can include reagents to detect viruses, such as COVID-19, SARS, MERS, Influenza, Zika, and others. Alternatively, two or more of the reaction chambers can include the same reagents, providing redundancy and Quality Control (QC) within the cartridge. In an example, all reaction chambers include the same reagents, such that the number of chambers having positive signals may confer a statistically-significant minimum number of analytes; for example, the minimum number of bacteria in a sample may be determined thus providing Quality Assurance (QA).

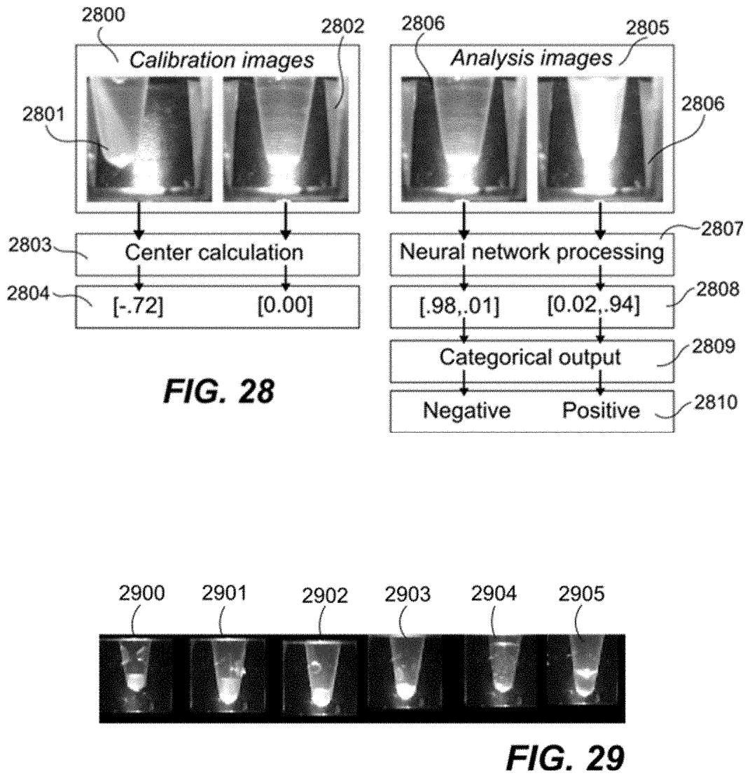

In another exemplary embodiment illustrated in FIG. 32 and FIG. 33, an instrument includes a heated lid 3320. The heated lid 3320 may be attached to the cover 106 and may be disposed above the cartridge 210 when the cover 106 is closed. The heated lid 3220 can include comprise a printed circuit board with a trace resistor for the dissipation of heat into the top of the cartridge. In another example, the heated lid 3220 can include a heater, such as a resistor or Peltier thermoelectric element. The heated lid 3220 can be at a different temperature than the incubation block and can function to reduce the occurrence of condensation at the top of the reaction chambers, which could affect the progress of a chemical reaction.

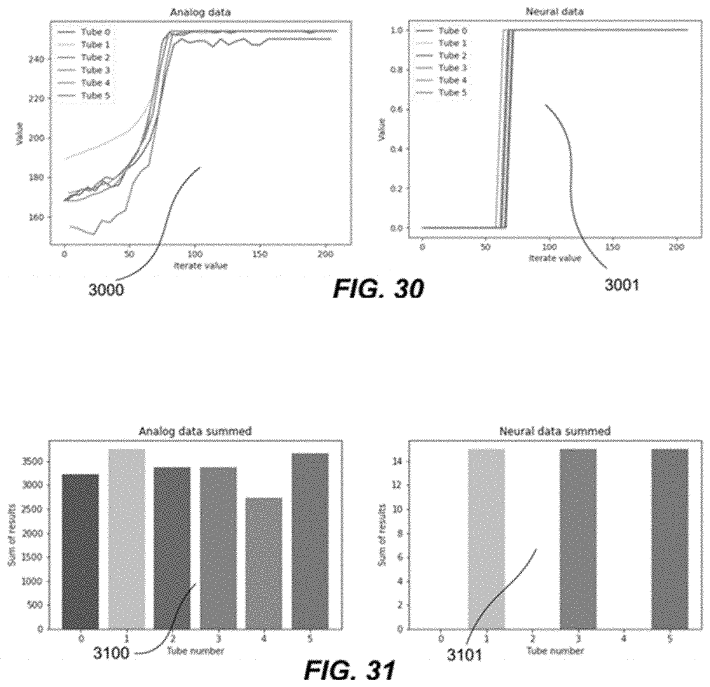

For example, as illustrated in FIG. 34, the heated lid 3220 may be supplied power through cables 3430 which are routed through an opening in the cover lever 3424. The cover 106 can be couple to the frame 3422 via a hinge 3428 and the cover lever 3424. The cover lever 3424 can include an arm extending to the hinge 3428. The cables 3430 can be shielded from user interference with the material of the cover lever 3424. In another example, wires 3430 can be routed through clips in the cover lever 3424.

The cover 106 and instrument deck frame 3422 can be connected with a separate hinge 3428, or, in an example, can be simultaneously manufactured to be interlocking, with an embedded hinge 3428. The cover 106 can be of the same body as the cover lever 3424 and include a pin which is positioned in a receiving opening of the instrument deck frame 3422. The pin may rotate in the receiving opening, thus allowing movement of the cover 106. The instrument deck frame 3422 and cover 106 may be manufactured simultaneously to allow for such interlocking function, for example through multi jet fusion or other forms of additive manufacturing. In another example, the hinge 3428 can be formed out of an inserted screw, or a separate hinge, or a bending mechanism

The cover lever 3424 can include material to trigger a cover switch, such that the instrument is able to detect when the cover 106 is opened. In an example, current to the light emitting diode is passed through the switch such that when the cover 106 is opened, the light emitting diode is incapable of emitting light. In cases where the excitation source is powerful, the light may cause temporary blindness to an operator, and a physical prevention of the circumstance provides a safety benefit. Additionally, if the cover 106 is open, the instrument can pause imaging activities and ask the user to close the cover 106, so as to not bias signal data with external light.

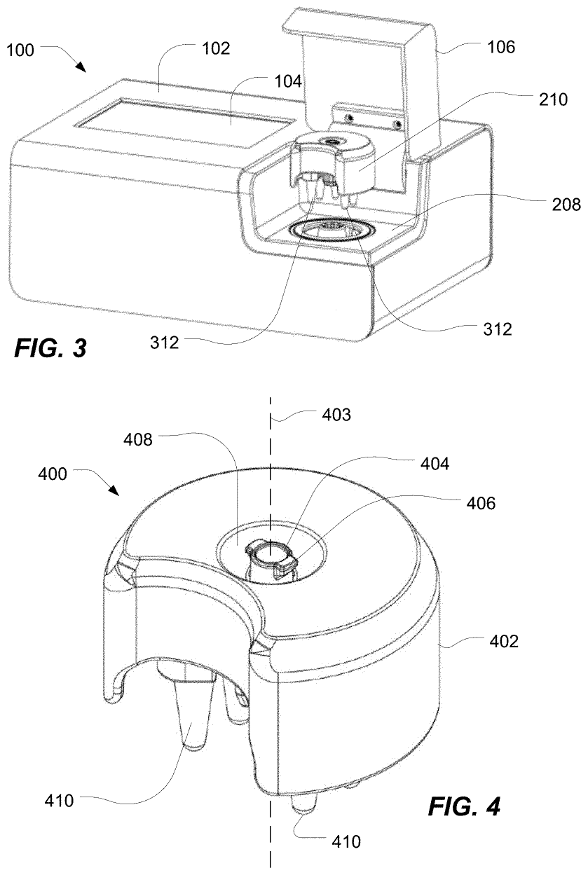

FIGS. 4-10 illustrate an example embodiment of a cartridge 400. As illustrated in FIG. 4, the example cartridge 400 includes a cartridge body 402 having an approximately cylindrical configuration around a central axis 403. An input port 404 is configured to receive a fluid sample and can be aligned with the central axis 403. Interior channels (see, for example, FIG. 10) of the cartridge 400 begin at the input port 404. Optionally, the input port 404 can includes flanges 406. The flanges 406 can, for example, form a male luer connector to which a female luer connector, such as a connector on a syringe, can be attached. For example, the port comprises a male luer tip incorporated into the shape of the cartridge such that a syringe with a female luer tip may be securely attached. The syringe, which contains a liquid sample, is depressed to transfer a liquid sample into the interior channels. Alternatively, an automated syringe, pump, liquid transfer device, pipette, or valve may be attached to distribute the liquid sample into the interior channels, so as to limit the differences in flow rate caused by different users.

Further, the cartridge 400 can include a plurality of reaction chambers 410. In an example, the reaction chambers 410 are microtubes coupled to the cartridge body 402. The reaction chambers 410 can be distributed at a radial distance from the central axis 403 and at different angles. The reaction chambers 410 can be formed from microtubes that are free of nucleic acids prior to the addition of reagents.

In use, a syringe or other fluid container can be coupled to the input port 404 and secured using flanges 406. Fluid can be injected through the input port 404 and into the reaction chambers for 410. Air escaping from the reaction chambers 410 can pass through an annular space 408 disposed around the central axis 403 and concentric with the input port 404.

As illustrated in FIG. 5, the cartridge body 402 includes couplings 520 to receive the reaction chambers 410. For example, a flange 522 of the reaction chambers 410 can click into place within the coupling 520 to secure the reaction chamber 410 to the cartridge body 402. Optionally, the nozzles 512 extend into the reaction chambers 410. Such nozzles 512 are in fluidic communication through a channel with the input port 404 and direct the fluid towards the bottom of the reaction chambers 410.

Further, the cartridge body 402 can define a central stem 514. The central stem 514 can optionally be shaped to have a cross-section of the gear with teeth that engage a complementary socket of the instrument. Alternatively, the cartridge body 402 can define a socket configured to engage a stem of the instrument. Further, the cartridge body 402 can define a space 516 within the stem 514 into which a magnet 518 is disposed. Such a magnet 518 can connect with an opposing magnet on the instrument or a ferromagnetic plug disposed on the instrument. Alternatively, the instrument can include a magnet and the cartridge body can secure a ferromagnetic plug.

The illustrated embodiment includes 6 reaction chambers. Alternatively, the cartridge can include more or fewer than 6 reaction chambers. For example, the cartridge can include between 1 and 20 reaction chambers, such as between 4 and 10 reaction chambers or between 4 and 8 reaction chambers.

When looking at a top view illustrated in FIG. 6, the input port 404 leads to a plurality of openings 624 in fluidic communication with the reaction chambers 410. The annular space 408 is concentrically formed around the input port 404 and is in communication with ports 626 that allow air or gas to leave the reaction chambers 410 as fluid is injected through input port 404.

Optionally, a gap 630 can be formed in the cross-section when viewed from the top, as illustrated in FIG. 6. Reaction chambers are distributed at a radial distance from central axis at different angles, except for within the gap 630. As described in more detail below, the gap 630 can be used as a calibration point to locate the centers of the reaction chambers.

FIG. 7 illustrates a side view of the cartridge 400 from a side including the gap 630. As illustrated, the reaction chambers 410 are distributed around the central axis 403, except within the gap 630. Such distribution of reaction chambers 410 is further illustrated in FIG. 8.

FIG. 8 includes an illustration of a bottom view of the cartridge 400. Reaction chambers 410 are secured within the couplings 520 and distributed at a radial distance (δ) from the central axis 403 at angular intervals (α), except within the gap 630. In an example, the angular intervals (α) are each equivalent. Alternatively, the angular intervals can be different. FIG. 8 further illustrates the gear cross-section of the stem for 514 and the positioning of the magnet 518 within the stem 514.

Further, gear teeth of the stem 514 can be distributed around the circumference of the stem 514. For example, the gear teeth can be evenly distributed around the circumference. In a particular example, the teeth can be distributed at angular intervals relative to adjacent teeth at the same angle as the centers of the reaction chambers. As such, when disposed in the instrument, the cartridge has a limited number of possible positions relative to a socket of the instrument receiving the cartridge.

FIG. 9 illustrates a further bottom view of the cartridge 400 absent the reaction chambers 410. As illustrated, in association with the couplings 520, a nozzle 512 extends into the space where a reaction chamber is to be connected. In addition, a gas port 932 is provided to a permit gas or air to leave the reaction chamber when liquid is injected through the nozzles 512 and into the reaction chambers 410.

As illustrated in the cross-section of FIG. 10, the injection port 404 is in fluidic communication with the reaction chamber 410 through a port 624, fluid channel 1036, and the nozzle 512. The volumes of the reaction chambers 410 are connected via a gas port 932 and a conduit 1038 to ports 626 leading to annular space 408. As such, when fluid is injected into the input port 404 it flows through nozzle 624 and channel 1036, and through nozzle 512 into the reaction chamber 410. Displaced air or gas flows out of the port 932 through the conduit 1038 and through the port 626 into the space 408.

The cross-section of FIG. 10 further illustrates the coupling 520, which includes an indentation 1034 to receive the flange 522 of the reaction chambers 410. Alternative coupling structures such as threaded structures or compression structures can be utilized.

The plurality of interior channels 1036 for liquid distribution form a manifold, whereby the channels 1036 emanate radially from the insertion port 404. This circular configuration provides comparatively equal distribution of liquid into each reaction compartment. In an example, the cross-sectional areas of the channels sum to a cross-sectional area not greater than the cross-sectional area of the insertion port 404. For example, in a cartridge with six reaction compartments, the cross-sectional area of each channel is at most one sixth of that of the input port 404. In an example, the diameter of each channel is 1 millimeter, and half a milliliter of liquid is dispersed in the cartridge and is dispersed in one second. The Reynolds number of the liquid as it goes through the interior channels 1036 and into the reaction compartments ranges from 100 to 2300, for example from 1000 to 1500, or from 600 to 800. Such values of the Reynolds number generally correspond with laminar flow of the liquid sample through the cartridge, which limits the pressure variation at the port 624, in turn equalizing the distribution of the liquid sample about the reaction compartments.

Each channel 1036 leads to a respective reaction chamber 410, following a path towards the bottom of the chamber 410 for the depositing of liquids. The exit from the channel 1036 may be a tapered nozzle 512 providing a high ejection velocity of the liquid, (owing to the decreasing cross-sectional area), limiting the adhesion of the liquid to the nozzle, and ensuring that the liquid reaches the bottom of the reaction compartment.

Variable viscosities and input flow velocities are accommodated by the cartridge. The net volume of the channels 1036 is low to limit the loss of input liquids. For example, with an input of one milliliter of liquid, the volume of the channels may be less than one fourth of the volume of liquid, for example less than one twentieth of the volume of the liquid.

Desirably, the liquid, upon distribution to the reaction chambers, is disposed fully at the bottom of each chamber 410 such that it is in contact with any chemical reagents present. A negative control signal can be obtained from the sample liquid absent further reagents. The signal can be used as a baseline for the evaluation of signals from other reaction chambers.

Additionally, it is desirable for equal volumes of liquid to be distributed in each reaction compartment, such that the concentration of chemical reagents is modulated precisely for a given chemical reaction. In the case of nucleic acid detection, the rate of amplification of nucleic acids in an isothermal reaction with precisely modulated concentrations of reagents can give valuable information regarding the quantitative presence of target nucleic acids. In an example, such quantitative analysis has value with regards to the quantitation of bacteria in water samples; ratiometric comparison of amplification results can provide benchmarks for obtaining sample bacteria counts.

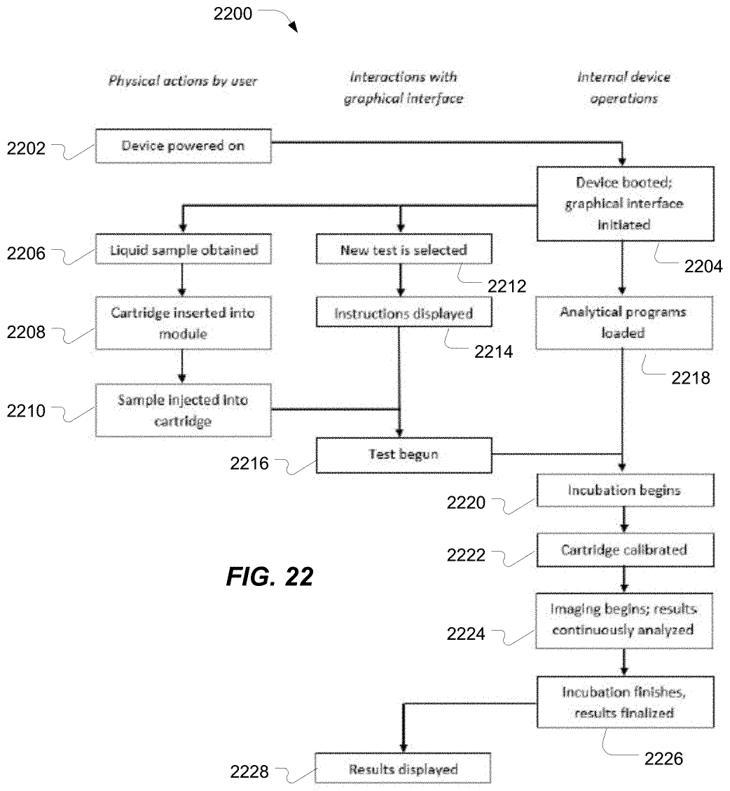

To ensure the equal distribution of liquids, additional features in the cartridge can limit the effects of turbulent flows in the interior channels, which can cause variances in distribution volumes among the reaction chambers. A conduit 1038 to vent air pressure in the reaction chamber can be present. The air conduit 1038 can lead to the region of the insertion port, such that a seal 2700 (FIG. 27) applied over the insertion port also encloses the air inside the cartridge, limiting the chance of airborne contamination. In another example, a cork-like structure about the tapered nozzle 512 can be added such that air may flow through the structure, but liquid has difficulty flowing through due to surface adhesion tendencies. The volume of the chambers 410 may range from 20 to 5000 microliters, for example from 100 to 1000 microliters or from 500 to 900 microliters. The volume of the chambers 410 must be large enough to collectively accommodate the volume of the liquid sample transferred therein.

The seal 2700 illustrated in FIG. 27 can completely cover the annular space 408. The seal 2700 has a front flap 2704 which can protrude over the gap 630 in the cartridge 400 and may be secured to the cartridge 400 with an adhesive. Hinges 2703 may consist of strips of material which are attached to the cartridge 400 by side flanges 2701, functioning to allow the temporary removal of the portion of the seal 2700 over the annular space 408 and input port 404, permitting the attachment of a syringe to the cartridge 400 for liquid sample insertion. After the liquid is transferred, the seal 2700 is reattached to the cartridge 400, which prevents the liquid from evaporating during the course of incubation at elevated temperature. The seal 2700 preserves the sterility of the cartridge 400 by covering the annular space 408, preventing any external particulates from entering the cartridge 400 or reaction chambers 410.

The seal 2700 may be pulled up by the front flap 2704 and is held onto the cartridge 400 by the side flanges 2701, with hinges 2703 weak enough for the seal to bend away from the cartridge 400. A restricting flap 2702 prevents tension force on the seal 2700 (when being pulled by flap 2704) from completely detaching the seal 2700 from the cartridge 400; the flap 2702 can only be removed by tension from the side of the seal 2700 opposite that of the front flap 2704, such that during regular operation the seal 2700 cannot be removed from the cartridge 400 without cleavage or tearing.

To limit changes in distributed liquid volume caused by evaporation in prolonged incubation protocols, a wax bead with sufficiently low melting temperature can be embedded in each reaction chamber such that an initial melting temperature causes the bead to melt to form a seal over an aqueous liquid sample. In an example, the wax bead can be deposited into a designated indentation on the nozzle during assembly of the cartridge.

Returning to FIG. 10, the reaction chambers 410 are desirably transparent, such that a color signal is visible on the exterior of the reaction chamber. It is also desirable for each chamber 410 to have various chemical reagents added upon assembly in a sterile manner, so as to limit contamination among the reaction tubes. In particular, each chamber is free of nucleic acids prior to addition of chemical reagents. To that end, the reaction chamber, e.g., transparent microtubes, have chemical reagents deposited prior to assembly. These microtubes are then securely fitted into designated grooves 1034 of the couplings 520 in the cartridge body 402.

The cartridge body 402 can define an exterior shell 1035, intended to be handled by a user. The shell 1035 can limit contact with the reaction chambers 410, further limiting the chance of signal degradation or contamination caused by grease or debris on the exterior of the reaction chambers 410. The exterior shell 1035 can further limit exterior light pollution from interfering with the measurement of light signals. In an example, the shell 1035 extends radially outwardly relative to the reaction chambers. The shell 1035 can extend to terminate at the same level as the stem 514 from a side view perspective (e.g., FIG. 7). In another example, the shell 1035 extends to at least partially cover from a side view perspective the reaction chambers 410.

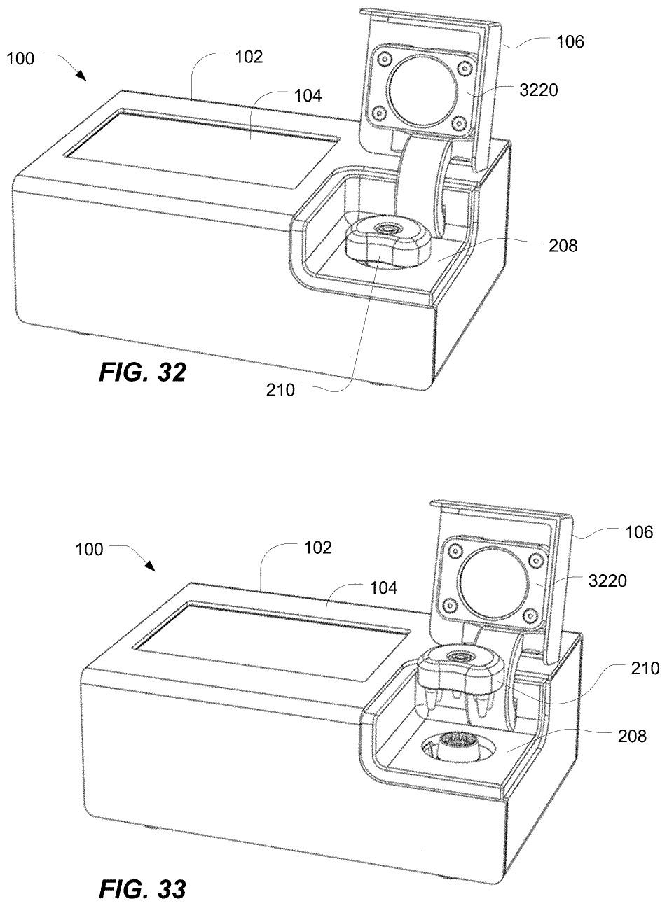

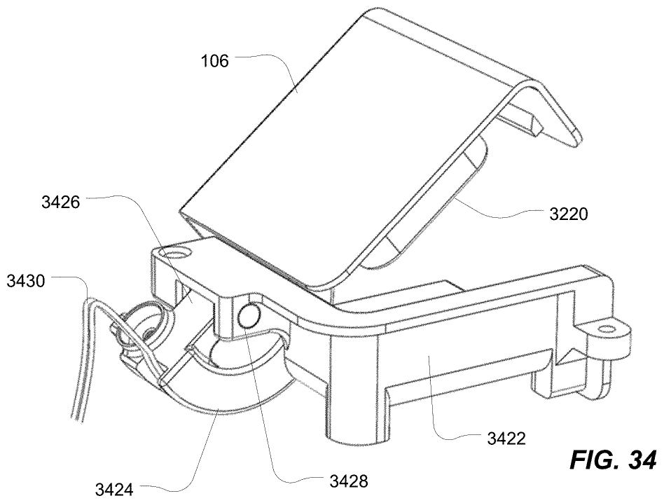

In another example embodiment, a disposable cartridge is illustrated in FIG. 35 and FIG. 36. The disposable cartridge includes a cartridge body 402 and a plurality of reaction chambers 3538 distributed radially about the center axis of the cartridge. Further, a magnet 518 can be disposed in a groove 516 in a shaft or stem 514 of the cartridge.

Each reaction chamber 3538 can attach to the cartridge at a nozzle 3530. The nozzle 3530 can include a vent channel 3534 and a fluid channel 3532, which are in communication with the channels in the cartridge body 402. The nozzles 3530 can be part of the cartridge body 402. The nozzle 3530 can further include a restraining ridge 3536, which can form an interference fit or can stretch the opening 3540 of a reaction chamber 3538 and restrain the movement of the reaction chamber. A positioning ridge 3544 can be included to restrain the movement of the reaction chamber 3538. Optionally, the positioning ridge 3544 can form an interference fit with a tapered section 3542 of the reaction chamber 3538. As such, a sealed environment can be formed with the interface of the material of the reaction chamber 3538 with the restraining ridge 3536 or the positioning ridge 3544.

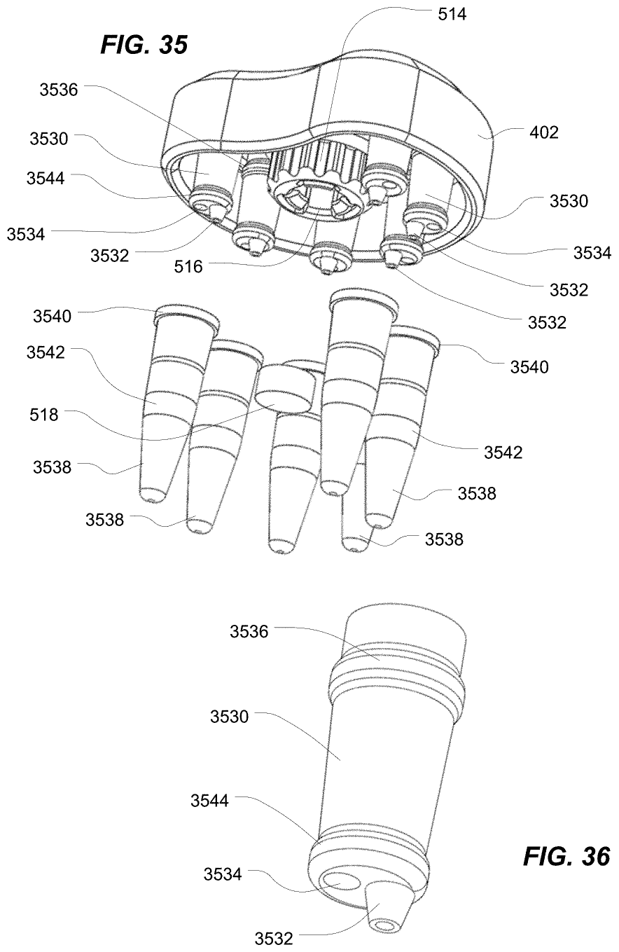

In a first example, a reusable cartridge including openings for interchangeable reaction tubes can be used with the instrument. An exemplary reusable cartridge 3702 is shown in FIG. 37, FIG. 38, and FIG. 39. The reusable cartridge 3702 can include a plurality of openings 3812, into which closed reaction chambers 3706, such as microtubes, can be placed. In an example, the cartridge 3702 includes one or more recesses 3710 configured to receive tops 3708 of the reaction chambers 3706. The cartridge 3702 can further include a shell 3704 extending at least partially around the reaction chambers from a side view perspective and disposed radially outwardly from the reaction chambers 3706.

The reaction chambers 3706 can be removed, and new ones inserted. Further, a magnet 518 can be disposed of in the shaft or stem 514 of the cartridge 3702. The magnet 518 can be secured with a layer of solidified material, such as a resin, or may be restrained by snapping clips, or other mechanisms.

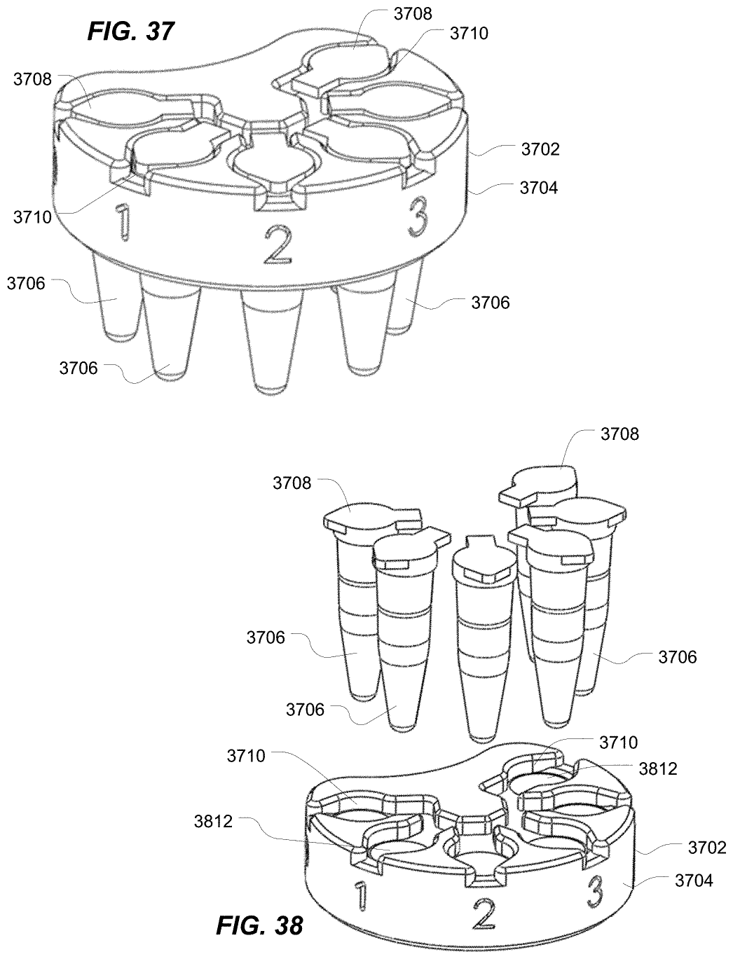

The reusable cartridge may be positioned in an incubation block 4020 such that the reaction chambers 3706 are above the light emitting diode 4026. For example, the reaction chambers 3706 can be disposed as illustrated in FIG. 40, with the reaction chamber 3706 moveable to a position directly above the light emitting diode 4026. Further, the reaction chambers 3706 can move through a channel 4022 in the incubation block 4020. The incubation block 4020 can include recesses 4024 to receive heating elements.

In an embodiment, a cartridge may be inserted into a measurement module for the purposes of executing chemical reactions in the cartridge and obtaining the results thereof. In an example, the module can conduct incubation protocols, such as for isothermal amplification of DNA, and subsequently collect color signals from the reactions, which may undergo incubations at various temperatures. The cartridge may also be heated to different temperatures for the execution of one chemical reaction; for example, a cartridge may be heated to high temperatures for lysing of cellular analytes and return to lower temperatures for signal acquisition.

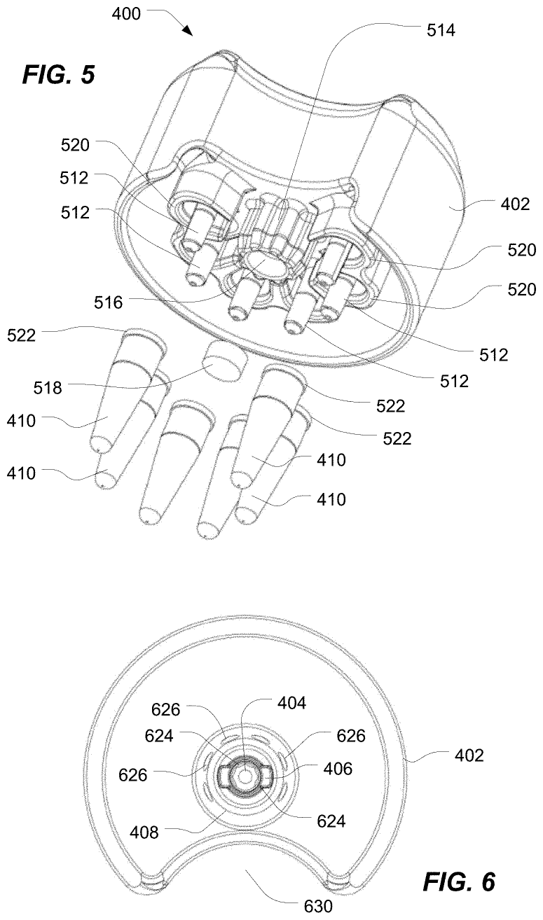

The cartridges, such as cartridge 210, illustrated in FIG. 11 are configured to be received by a deck 208 of a module and to be rotated by a motor 1114 into positions for measurement. For example, as illustrated in FIG. 12, the deck 208 includes an opening 1218 to receive the reaction chambers and a socket 1216 to receive the stem of the cartridge 210. In an example, the socket 1216 includes teeth configured to receive the gear teeth of the cartridge stem 514.

FIG. 13 includes an exploded view illustration of parts of a measurement module 1300 of the instrument. Below the deck 208, an incubation block 1318 including a central heating block 1320 is disposed in a tray 1326. The heating block 1320 defines space, such as a circular grove, to receive the reaction chambers of the cartridge. The circular grove is of a shape to closely encompass the reaction chambers of the cartridge, while permitting the rotation of the cartridge.

Heater elements 1322 are disposed within the incubation block 1318, for example, along the perimeter or around the heating block 1322. In an example, the heaters 1322 are resistance heaters. Heat is transferred through conduction from the heaters 1322 to the incubation block 1318 including heating block 1322, and by convective or radiative emission to the reaction chambers, thus heating the contents therein. In contrast, traditional means of stationary incubation utilize tight contact between reaction compartments and a heating element. In the present example, the reaction chambers are generally at a different temperature than the heating block 1322. This difference can be experimentally determined and used to implement desired temperatures for the reactions taking place in the cartridge.

The tray 1326 can further define and opening 1324 to receive aspects of an imaging device. For example, the imaging device can include circuitry 1330 to which a camera or other imaging device 1350 is attached. The circuitry 1330 fits into a block 1328 and secures the camera 1350 to the assembly 1300. Further, a window 1332 can be disposed within the opening 1324. Optionally, the window 1332 is colored and acts as a filter. Alternatively, the window 1332 can be replaced by other optical filters that limit extraneous light of undesired wavelength or excitation light to be received by the camera or other imaging device 1350.

A further circuit board 1334 can include one or more illumination sources, such as light emitting diode 1338. The illumination source can allow for visual identification of the reaction chambers. Further, the illumination source can illuminate the reaction chambers for viewing the color of a reaction. In another example, the illumination source can provide excitation energy for signal acquisition. In an embodiment, a blue light source can provide excitation energy for fluorescence of reaction products. The circuit board can further include a sensor, such as an analog light sensor, to detect functionality of and calibrate the light emitting diode 1338. The circuit board can further include a thermometer 1336, such as a thermistor, or other temperature measuring device, to detect a temperature of the incubation block 1318.

In the illustrated embodiment, illumination or excitation light is provided from below the surface of the tray 1326. The window 1332 and camera 1350 are disposed along an optical path that is perpendicular to the optical path of the illumination or excitation light generated by the diode 1338. In an example, the camera includes a charge-coupled device (CCD) camera or a complementary metal oxide semiconductor (CMOS) camera. The window 1332 can be made of a clear thermostable plastic, which can maintain clarity and isolate the camera from debris that could come through the opening of the incubation block 1318. The light filter may permit certain wavelengths of light to pass through and limit others, which can limit noise and augment signal clarity. In the case of fluorescent reaction product, the fluorescence may be filtered from the excitation light, which may be of a different wavelength. A light filter is used that permits fluorescent signals and blocks the excitation light, which would otherwise cause excessive noise. In an example, the filtration is weak enough such that without a fluorescent signal, a reaction compartment can be visually identified. In an example, the fluorescence filter is designed to filter out blue light while permitting green fluorescence from a fluorophore, such as fluorescein, which is excited by the blue light. The fluorescence filter can be a plastic sheet with optical filtration properties that is placed securely behind the viewing window.

The motor 1114 can connect through the tray 1326 and the heating block 1318 to the socket 1216 that receives the cartridge. The motor 1114, such as a stepper motor, is mounted to turn the cartridge. The turning is accomplished via an attached shaft that passes through the incubation block 1318, with a corresponding groove matching that of the stem on the cartridge. When the motor rotates the shaft, the torque is conferred through the shaft to the socket 1216 and to the to the stem 514 of the cartridge 402, turning the cartridge and its reaction chambers in the incubation block 1318. The rotation allows for all of the reaction chambers to be viewed by a single detector, limiting the errors introduced by mixed calibration of multiple sensors. The socket 1216 may contain a magnet or ferromagnetic plug to securely connect with the cartridge.

FIG. 14 includes a top view illustration looking down upon the deck 208. The socket 1216 is centrally located. A window 1440 through which the excitation or illumination light is provided and, as illustrated, the excitation or illumination light is directed out of the drawing. The window 1332 providing optical access to the camera is positioned perpendicular to the direction of excitation or illumination light coming through window 1440.

FIG. 15 illustrates a side view of the deck 208 and assembly in which the socket 1216 optionally extends out above the deck 208 to receive the cartridge. The cartridge shell sits above the deck. The tray 1326 is secure below the deck. The motor 1114 is secured below the tray 1326 and connects through the tray 1326 to the socket 1216. FIG. 16 includes a bottom view in which the motor 1114 is connected to the tray 1326 and the circuit board 1334 that includes the illumination or excitation diodes is connected to the tray 1326. The imaging apparatus 1328 is secured adjacent to the tray 1326.

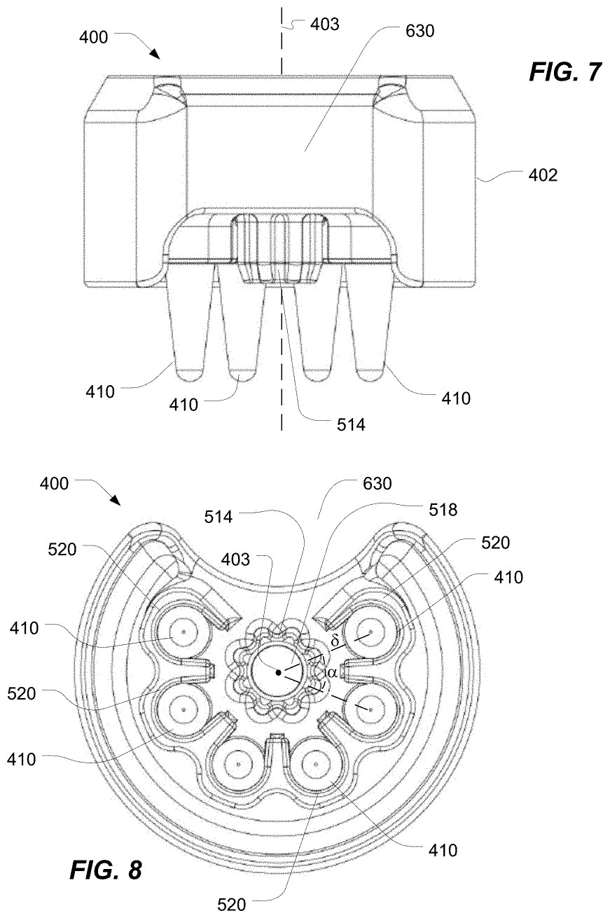

While the embodiment of FIG. 13 illustrate a horseshoe-shaped heating element, alternatively shaped heating elements can be used. For example, FIG. 17 includes an illustration of an alternative configuration of heating elements. For example, rectangular heating elements 1722 can be disposed on either side of the heating block 1720 within the tray 1326. FIG. 18 illustrates an exploded view in which the rectangular heating elements 1722 are applied on either side of the heating block 1720 inserted into the tray 1326. As above, a circuit board 1334 including illumination and excitation source 1338 is attached under the tray 1326. A motor 1114 is attached to the tray 1326 and connects with a socket 1216 through the heating block 1720 and the tray 1326. On a perpendicular optical path, a window or filter 1332 is coupled in front of the camera 1350.

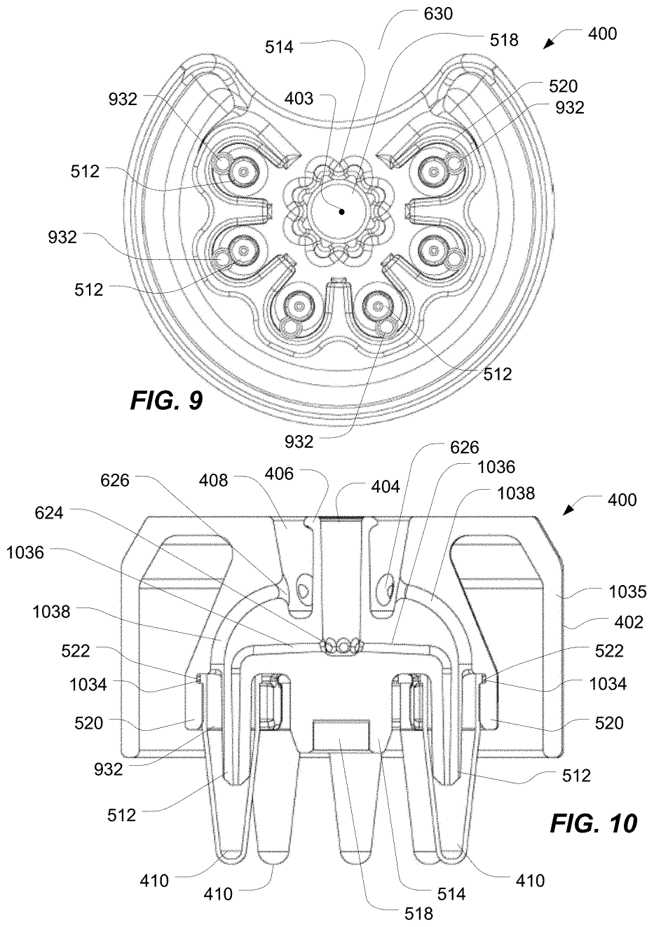

FIG. 19 illustrates a cross-section of the example heating block 1720. Space 1944 is provided for the rectangular-shaped heating elements. Further, a channel 1946 is provided to receive the reaction chambers of the cartridge. In addition, a central bore 1948 is provided through which the socket 1216 can connect to the motor 1114.

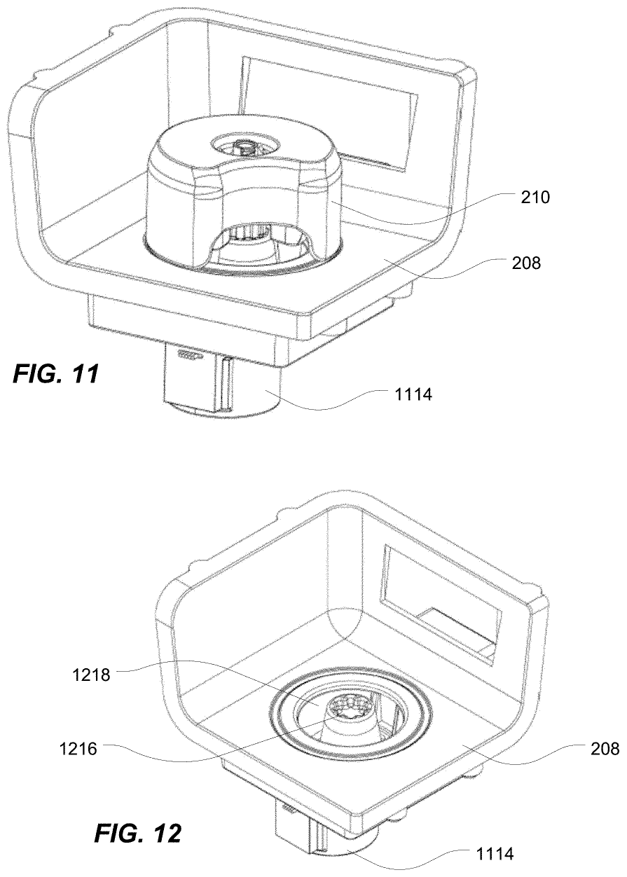

FIG. 20 illustrates a further view in which the reaction chamber 2052 can be moved into position at the intersection of the optical path 2054 of the illumination or excitation diode 1338 and the optical path 2056 of the imaging device or camera 1350. As illustrated, the window 1332 or filter is provided along the optical path 2056 limiting the amount of illumination or excitation light that reaches the imaging device or camera 1350. Positioning of the reaction chamber 2052 at the intersection of the optical paths 2054 and 2056 can be accomplished by calibration, as described in more detail below.

In practice, the heating block heats the reaction chamber 2052 to a temperature. In the case of isothermal reactions, the temperature of the heating block can be maintained at a constant temperature. As the reactions proceed, color or fluorescence associated with byproducts of the reaction can change. Such change can be measured by illuminating or exciting chromophores or fluorophores within the reaction chamber 2052. Light emanating from the chromophores or fluorophores can pass through the window or filter 1332 and into the imaging device or camera 1350 along the pathway 2056.

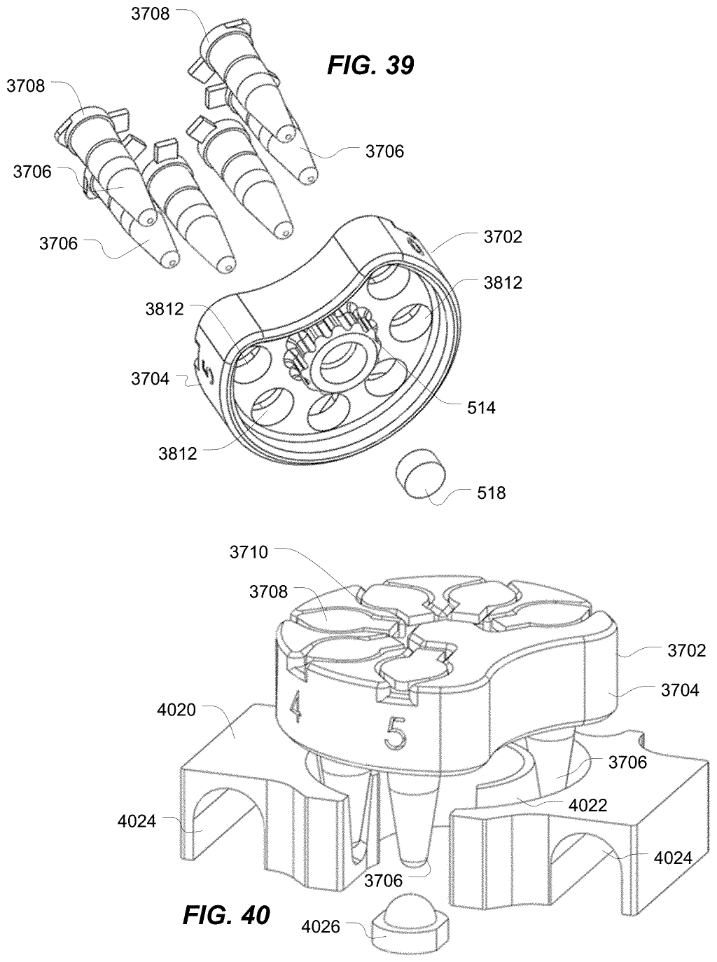

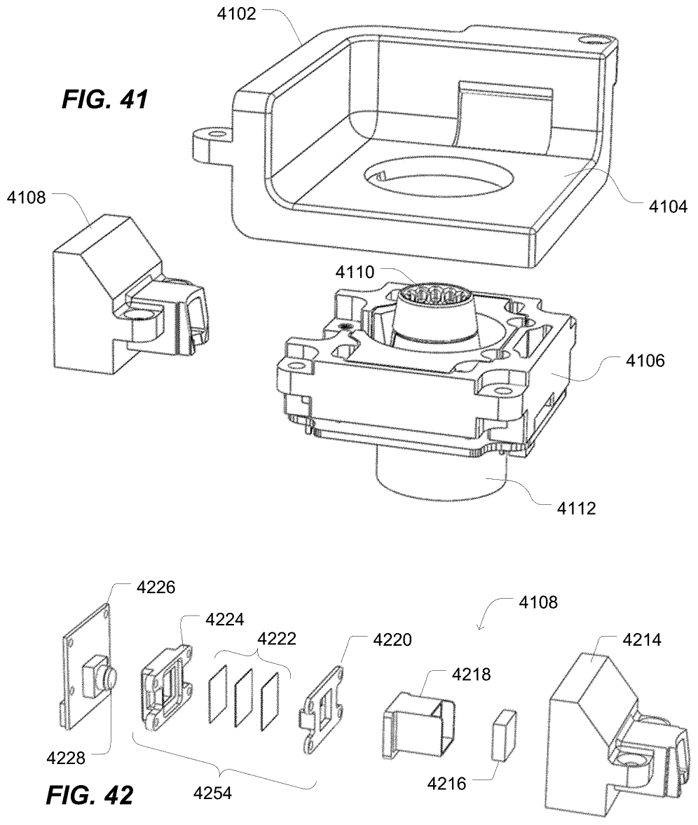

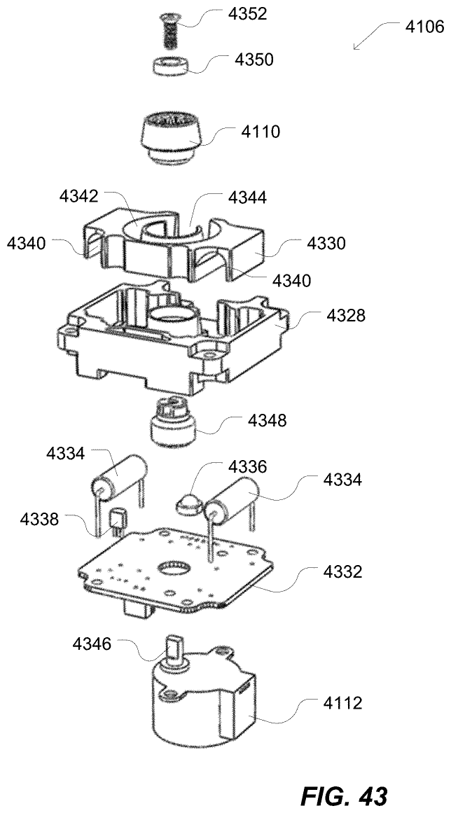

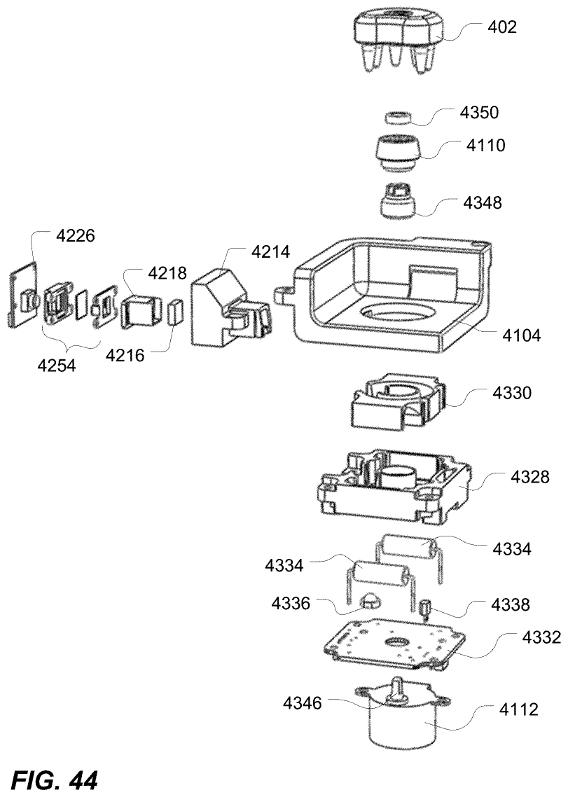

In a further embodiment illustrated in FIG. 41, FIG. 42, FIG. 43, and FIG. 44, an instrument deck 4102 can interface with a camera module 4108 and a heat module 4106 to form the measurement module. In an exemplary view of the modules and instrument deck illustrated in FIG. 41, the camera module 4108 is positioned to view reaction chambers passing through a channel of the heat module 4106. For example, a cartridge engages the socket 4110 of the heat module 4106, placing reaction chambers in a channel of the heat module 4106 and a shell positioned above a deck surface 4104 of the instrument deck 4102.

In an example, the camera module 4108 includes a plurality of components aligned with the view of a camera 4228, as illustrated in FIG. 42. A plurality of light filters 4222 may be positioned between frames 4224 and 4220, forming a filter module 4254. A window 4216 can be positioned by a window spacing component 4218. The camera 4228, light filters 4222, frames 4224 and 4220, window 4216, and window spacing component 4218 can be mounted to a camera module block 4214.

In an example, the heat module 4106 includes an incubation block 4330 positioned in a tray 4328, such as illustrated in FIG. 43. The incubation block 4330 can be held in place by a socket 4110 which is attached to a motor socket 4348 on the opposite side of the tray 4328, such as with a screw 4352. A cartridge magnet 4350 can be secured in the socket 4110 with the screw 4352. A circuit board 4332 can include heating elements 4334, a light emitting diode 4336, and a thermometer 4338. A motor 4112 can have a shaft 4346 to interface with the motor socket 4348, passing through the circuit board 4332.

The incubation block 4330 can include a channel 4342 through which reaction chambers of a cartridge can move. In addition, the incubation block 4330 can include recesses 4340 to receive the heaters 4334. In addition, the incubation block 4330 and the tray 4328 can include an opening 4344 to permit access by the camera 4228.

The alignment of elements in the measurement module can be such that the cartridge is rotated within the incubation block by the socket 4110, as illustrated in FIG. 44. The camera module 4108 can be at an angle to the axis of the cartridge rotation.

Plastic structural elements can be attached to an outer casing with fixtures, such as screws and standoffs. In an example, the plastic structural elements are manufactured with multi jet fusion (MJF), involving the sintering of layers of powdered nylon to achieve geometries for the attachment of other components, such as threaded holes and wire clips for other plastics and electronics. In another example, the plastic structural elements are manufactured with injection molding, or with selective laser sintering, or with casting, or with additive manufacturing. The measurement module can directly attach to the outer casing with screws or can be attached to other plastic structural elements.

In an embodiment, an instrument contains the measurement module along with additional components. An embedded microprocessor controls the devices of the module (comprising the motor, light source, thermometer, and camera) while conducting additional functions. The instrument can contain a graphical user interface, which can be operated via a touch screen display, for external control.

In an example, the measurement module is secured inside a casing with a microprocessor controlling a touch screen display. The devices of the module may be controlled by the microprocessor, which is mounted on its own printed circuit board and connected to the printed circuit board of the measurement module.

Additionally, the measurement module can be isolated from light by a cover. Preventing light from entering the module is desirable, as the light can cause signal discrepancies. The cover can be connected to a hinge and operated by hand, as illustrated in FIG. 2 and FIG. 3.

In a particular example, the instrument comprises the measurement module, a fitted cover, an interior fan for cooling of electrical components (such as the microprocessor) and a touch screen display. The position of the module and the cover is such that insertion of the cartridge into the module is simple, with a large exposed space limiting the precision necessary for such insertion.

The components of the instrument may be secured together with screws, as may be the components of the measurement module, or may be secured with snap hinges, or other connecting structures, such as locking tabs or hooks. The components can be made out of a variety of materials, with varying properties to accompany desired structural and functional characteristics. The exterior-facing components of the module may be made out of a thermostable and insulating plastic, limiting heat loss while reducing the risk of a burn to the user.

The instrument may be powered by interior batteries or an external power source. In an embodiment, the instrument uses comparatively little power, enabling portable applications. Isothermal incubation is less energetically expensive, allowing the disclosed instrument to function with low power input.

While the embodiment of the instrument illustrated in FIG. 1, FIG. 2 and FIG. 3 includes a single measurement module to receive a single cartridge, the instrument can be configured with more than one measurement module, each to receive a cartridge. For example, the instrument can be configured with between 2 and 10 measurement modules, such as between 2 and 6 measurement modules, for example, 3 measurement modules to receive 3 separate cartridges.

Several components of the instrument can be manufactured using additive processes, such as digital light processing (DLP), whereby liquid resin is solidified in layers, forming a final part. This additive manufacturing process is capable of making the complex geometry of the cartridge, which is not possible with standard injection molding techniques. Additive manufacturing of the parts permits the design of efficient geometries that improve material usage and structural stability. Different kinds of additive manufacturing may be used to make the cartridge and other parts of the instrument; for example, fused deposition modelling (FDM), stereolithography (SLA), and selective laser sintering (SLS) may be used to make such parts.

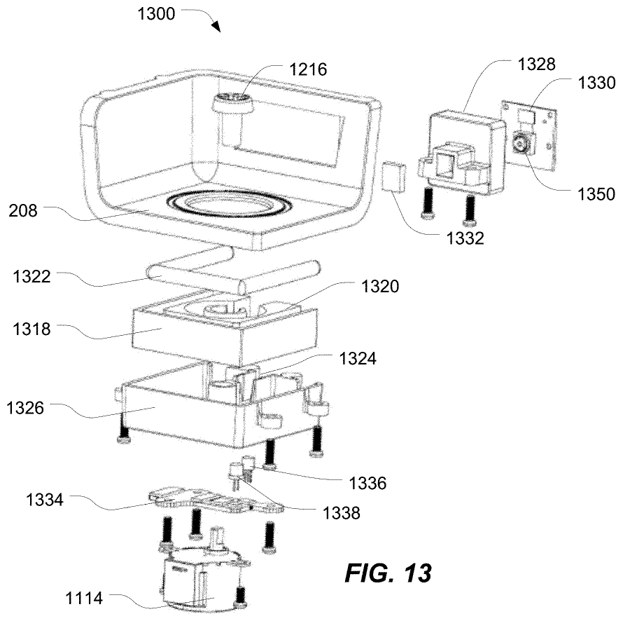

FIG. 21 includes a block diagram illustrating further structures and modules within the instrument. A functional module 2100 can interact with the heating block 1720, a thermometer 1336, and a heater, such as resistive heaters 1722, to heat the reaction chambers of the cartridge. Further, the functional module 2100 can be connected to a detection system 2114 that incorporates the illumination or excitation light emitting diodes 1338, a camera 1350, and a light filter 1332 disposed between the reaction chambers and the camera. In addition, the functional module 2100 can connect to a stepper motor 1114 that rotates the cartridge to positions optimal for measuring results using the detection system.

The system can further include structural elements 2108 such as power sources 2110, including a line source or a battery and power supplies. Other structural elements include a casing 2111 and a user interface, such as a touchscreen display 2109. The system can further include a fan 2112 to cool the various electronics and the heating block associated with the instrument. Each of these functional modules and structures can be controlled using control system 2104 implemented in a microprocessor 2106 using embedded memory 2105 or other control circuitry 2107.

In an exemplary embodiment, the instrument 100 of FIG. 1 has a plurality of subsystems, for, example, illustrated in FIG. 21. The instrument 100 includes a functional module 2100 where a measurement module 1300 can receive a cartridge 400, in which a chemical reaction can take place, the results of which are obtained by the measurement module 1300. The functional module 2100 comprises a heating block 1720 which, for example, can be heated by a resistor 1722 and measured with a thermometer 1336, facilitating incubation of the cartridge 400 at a desired temperature, or optionally, multiple temperatures. For example, a detection system 2114, comprising a camera 1350, an excitation light source, such as an LED 1338, and a light filter 1332, in communication with the functional module 2100 and can be used to record signals and images from the cartridge 400, which may be rotated by a stepper motor 1114. The functional module 2100 is contained within a structure 2108, which is held in a casing 2111. The casing 2111 has attached to it various structural components, a display 2109, power inlet 2110, and fan 2112, among other subsystems. The functional module 2100 is interfaced with a control system 2104 comprising a microprocessor 2106 which controls the instrument 100 with control circuitry 2107 and having access to embedded memory 2105.

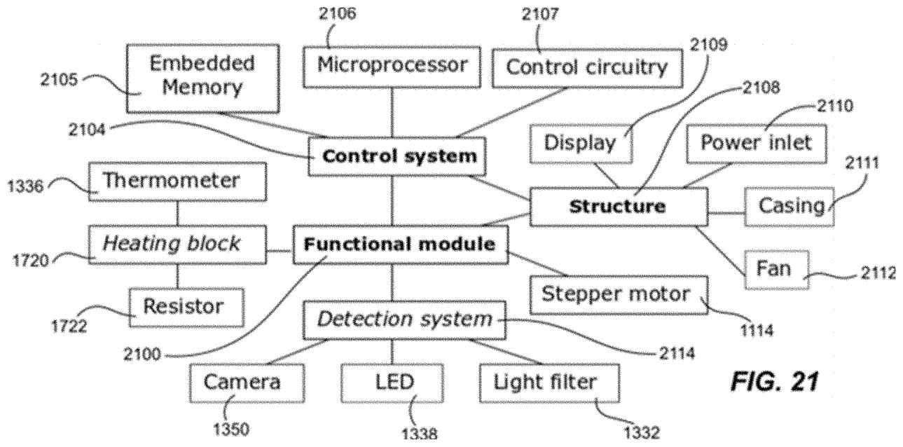

In a further example, the instrument 100 of FIG. 1 includes hardware and software to facilitate communication with external devices. For example, the instrument 100 contains elements 2600, such as an internet-accessing module and embedded storage, which can communicate with a connected device 2611, such as a smartphone or laptop, and a server 2608, as illustrated in FIG. 26. Information exchange or control of the instrument 100 may be facilitated through virtual activities 2604, such as data transfer 2606 and transfer of software updates 2607. Data transfer 2606 may be conducted through protocols such as the Secure File Transfer Protocol (SFTP), Bluetooth, HTTP, or other protocols. Data and image transfer 2606 may also involve sending data for further processing by neural networks on the server 2608. The neural networks 2603 stored on the instrument may undergo updates 2607 from the server 2608, which contains a database 2610 of other neural networks and data collected from other devices and chemistries. The server 2608 may conduct additional neural network training 2609 following the data transfer 2606 of information in the instrument 100 data storage 2602, which trains new neural networks that can be transferred to the instrument 100 and connected device 2611. The connected device 2611 can have result storage 2612 and data analysis 2613 of data obtained through data transfer 2606 between the instrument 100 and connected device 2611, such as through the application of additional neural networks in analysis of images. Commands 2605 may be issued by the connected device 2611 to execute programs 2601 in the instrument 100, such as running duplicate chemical reactions or connecting to the internet.

In an embodiment, the software executed by the embedded microprocessor controls the devices of the module, the graphical user interface, and the function of the instrument. The module may be connected to the microprocessor via an assembly of cables, such as those for powering the heating resistor and obtaining data from the camera.

Software can provide the graphical user interface used during instrument operation for control of various instrument functions and for displaying the final results. The graphical user interface may feature buttons along with instructions for operation of the instrument.

In an embodiment, the software is designed for an untrained user; hence, the procedures for operating the instrument are comparatively simple. For example, upon selecting the execution of a given chemical reaction, the software begins a variety of processes for doing so. In an example, the software conducts data analysis, granting final results (such as a qualitative presence or absence of a particular target).

The measurement module can be raised to a given temperature by powering the heating resistor while monitoring the input from the thermometer. Once a desired temperature is reached, it is maintained for a desired time, constituting incubation. Inevitable heat loss cools the heating block, utilizing repeated powering of the resistor to maintain a given temperature. Different temperatures may be maintained for incubation, and different temperatures may be reached during a chemical reaction.

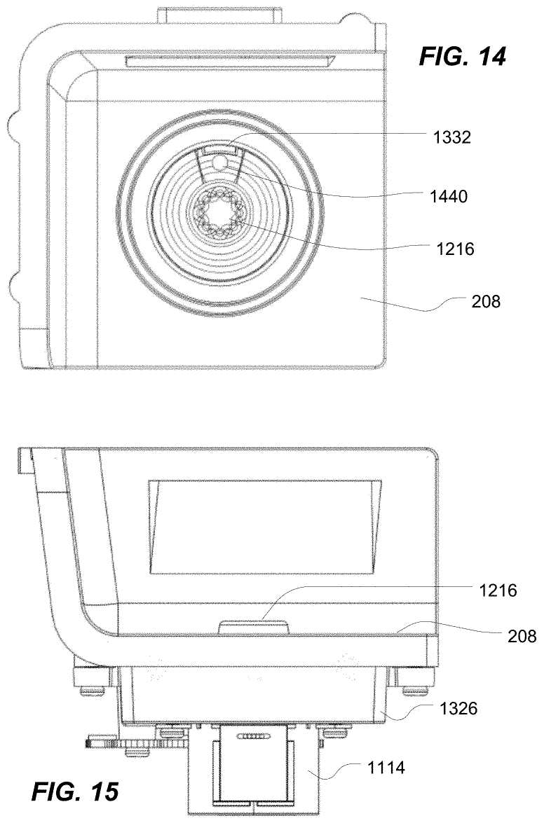

FIG. 22 includes a block flow diagram of an example method 2200 for operating the instrument. In an example, the instrument is powered on, for example, by a user, as illustrated at block 2202. Microprocessors, memory, and a graphical user interface can be initiated or booted, as illustrated at block 2204. For example, the internal instrument operations can load instruction sets, analytical programs, and user interface screens into memory, as illustrated at block 2218. The instruction sets and analytical programs can be used to implement testing and the user interface screens can implement a user interface through a touchscreen.

As illustrated at block 2206, the user can obtain a liquid sample. For example, the user can obtain samples, lyse cells, or purify other samples such as water samples, blood samples, swabs, fecal, or urine samples. In an example, a water sample may be used. In another example, nasal or throat swabs can be used.

The cartridge can be inserted into the diagnostic instrument, as illustrated at block 2208. For example, a cartridge in which reagents associated with the desired test or tests are dried or lyophilized within the reaction chambers of the selected cartridge. As illustrated at block 2210, the liquid sample can be injected into the cartridge, initiating the reaction.

Through interactions with the graphical user interface, the user can select a particular test associated with the selected cartridge and the desired test, as illustrated at block 2212. The system can then display instructions associated with carrying out the selected test, as illustrated at block 2214. Alternatively, the camera 1350 may identify the cartridge as being specific to a given test, and auto select the correct test. For example, a visual pattern or barcode on the cartridge may be recognized to determine the corresponding test. Once the liquid sample is injected and the system is initiated, the test begins, as illustrated at block 2216.

For example, the test can include incubation at a selected temperature, as illustrated at block 2220. In particular, the present instrument finds particular advantages in performing tests involving isothermal conditions.

As the reactions proceed, the cartridge position is calibrated, as illustrated at block 2222. For example, the system can test through image processing to find a center of a reaction chamber and then find a gap associated with the cartridge. Based on the positioning of the gap and center of the reaction chamber, the system can calibrate and can move reaction chambers in alignment with the camera system and illumination sources.

Accordingly, imaging can begin, as illustrated at block 2224. For example, the results can be continuously monitored by either monitoring a single reaction chamber or moving between reaction chambers to monitor states or conditions elucidated by the chromophores or fluorophores associated with the reaction. Should data be desirable for the entire duration of the chemical reaction, the imaging of the cartridge commences immediately.

As the incubation finishes, final results can be obtained, as illustrated at block 2226. Depending on the nature of the analysis, the system can analyze the images and display the results, as illustrated at block 2228.

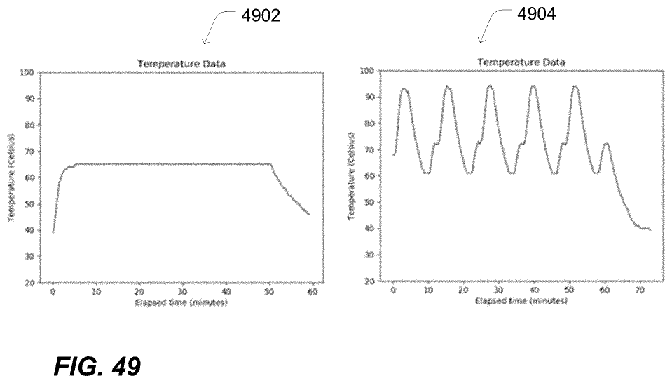

Chemical reagents in reaction chambers may be kept at single temperature (e.g., 4902 of FIG. 49) for a duration of time, or a plurality of temperatures (e.g., 4904 of FIG. 49) for other durations, as part of a temperature profile. In an example, an isothermal temperature profile may be used for executing an isothermal assay at 65° C. for 50 minutes, followed by a cooling of the reaction chambers for 10 minutes. Cooling may be needed, for example, to distinguish from positive and negative assay results. In an example, assays may fluoresce at elevated temperatures, requiring cooling for signal acquisition. In another example of a temperature profile, a thermal cycling temperature profile may include reaching temperatures of 94, 60, and 72° C. in sequence repeatedly.

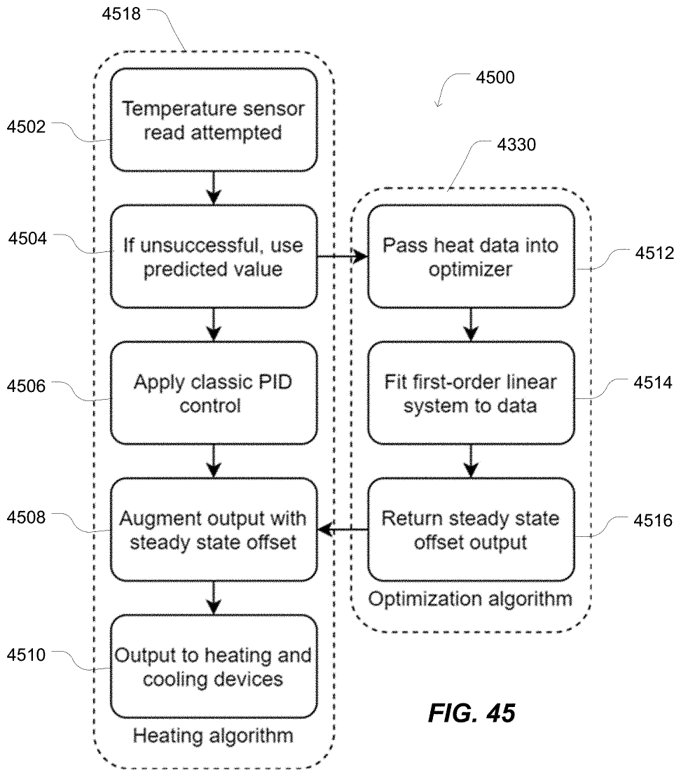

The temperatures of a temperature profile can be reached with the control of heating devices. Such heating devices may include heaters, a heated lid, a Peltier thermoelectric element, or a fan. The output power to such devices may be calculated with a heating algorithm. In an example method 4500 illustrated in FIG. 45, a heating algorithm 4502 includes a plurality of steps. A temperature sensor is read, as illustrated at block 4502. If the read is unsuccessful, such as may be if the sensor is not prepared to be read, a predicted value of the temperature is used, as illustrated at block 4504.

Heating data, such as the prior output power and temperatures, is passed into an optimization algorithm 4520, as illustrated at block 4512. The optimization algorithm may fit a first-order system, for example, comprising a linear combination of heating data parameters, to the prior temperatures, as illustrated at block 4514. Other systems may be used, for example second order systems or non-linear combinations of heating data parameters. The optimization algorithm calculates the steady state offset to compensate for environmental effects on the temperature output, as illustrated at block 4516. For example, in a cold environment, more power may be required to keep reaction chambers at elevated temperatures. The steady state offset is then passed into the heating algorithm 4518.

The heating algorithm 4518 may apply proportional-integral-derivative (PID) control to calculate a base heat output, as illustrated at block 4506. The output is then augmented with the steady state offset, as illustrated at block 4508, and the heating devices are controlled to perform the output, as illustrated at block 4510.

In another example, a heating algorithm can use the steady state offset from the optimization algorithm to calculate the needed heat output for reaching a target temperature within a given period of time. A prediction may be made for the temperature after a period of time, and heat output may be constructed so as to reach a desired temperature after the time has elapsed.

In an example, the position of the cartridge is first determined by using the camera and algorithmic computations. The camera takes pictures, and an algorithm is applied to identify the center of a reaction chamber (if present in the field of view of the camera). The reaction chambers are visible due to the light source illuminating them.

The center of the reaction chambers can be found by finding the positional center of brightness in a picture taken by the camera. For example, a weighted average of pixel color intensities according to coordinate position is determined. A threshold can be applied to limit the background noise, such as that caused by the light source itself. The result of the center-finding algorithm is a coordinate center point that approximates the center of the visible reaction compartment.

The cartridge is then rotated by the motor until a characteristic gap in the circularly distributed reaction chambers is found. This gap provides a definitive measure of the angular position of the cartridge. This position is then used by the software to rotate the cartridge to the position of a first designated reaction chamber, finishing the calibration procedure.

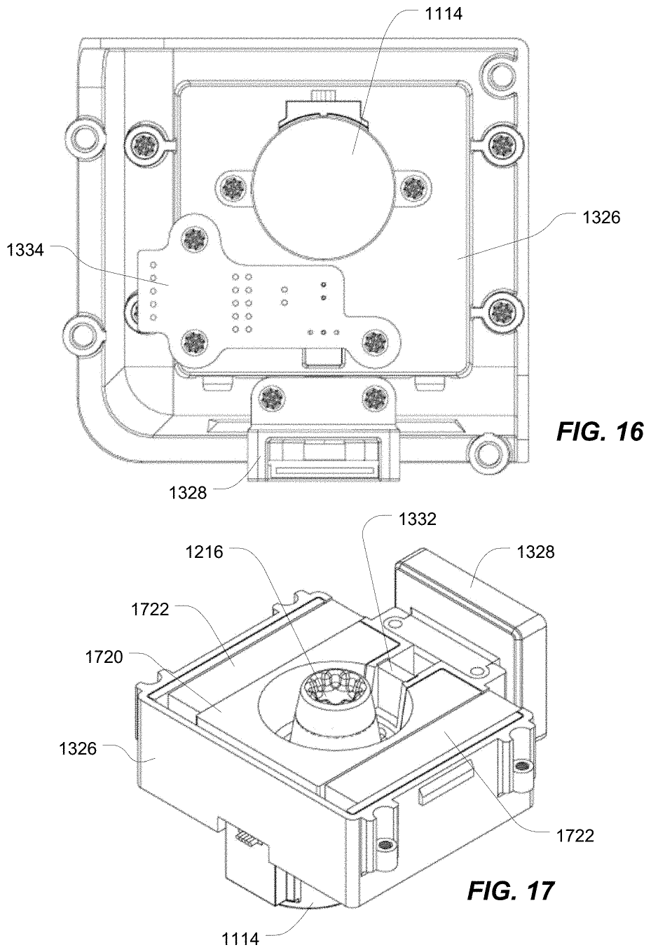

For example, FIG. 23 includes a block flow diagram of an example method 2300 for calibrating the instrument to determine positioning of the reaction chambers and preferred positioning to acquire images. For example, the instrument can undergo set up, as illustrated at block 2302. Set up can, for example, include turning on the light emitting diode, as illustrated at block 2304, and performing a light balancing operation, as illustrated at block 2306. Optionally, light balancing can be implemented using feedback from an analog detection device or by use of the camera 1350.

The system can utilize image processing to determine a center line of a reaction chamber, as illustrated at block 2308. For example, under the illumination of a light-emitting diode, and utilizing a camera, an image can be taken, as illustrated at block 2310. The image can further be processed by applying a grayscale for converting a color image, as illustrated at block 2312. By analyzing the intensity of the light signal using the grayscale image, a mean intensity can give a center of the reaction chamber, as illustrated at block 2314. Optionally, if there is a low confidence that a desirable center is located, as illustrated at block 2316, the system can take a further image, as illustrated at block 2310. When the center is located, the cartridge can be rotated until it aligns to the light-emitting diode, as illustrated at block 2318.

After identifying the center line of a reaction chamber, relative positioning can be determined, as illustrated at block 2320. For example, the system can rotate based on the known tube spacing, as illustrated at block 2322, to find a gap defined by the cartridge. Once the gap is located, the calibration is complete, as illustrated block 2324. With such a calibration, the instrument can rotate each of the set of reaction chambers into position to be illuminated by a light or excitation source and align with the imaging device.

Following positioning of the reaction compartments, the camera can take additional pictures, which are then used for signal determination. Various signals can be obtained from the pictures.

Algorithmic computations can be applied to find an average color signal, as well as that of an individual color channel detected by the camera. For example, a selection of pixels about the algorithmically determined center of the reaction compartment is averaged according to brightness and individual color channels. In the case of fluorescence, such as that of fluorescein, the green channel may be used to provide an analog measurement of overall signal

A neural network can be applied to the photographic signals. The neural network is constructed according to an architecture and a set of training data. For a given chemical reaction, a separate neural network may be used to analyze the results. The training data can include pictures of known samples having generated appropriate signals. In the case of fluorescence, positive and negative control signals in the reaction compartments are photographed by the camera. The photographs can be used to train the neural network.

The neural network has an architecture defined by layers of processing steps, whereby images may undergo processing by many such layers, which may serve as input into other layers, and eventually generate categorical results with different levels of confidence. In an example, a neural network has layers involving the spatial convolution of a matrix kernel about images, generating a smaller image which is used as an input for other layers with parameters that process such images to give further data. The neural network training procedure involves the optimization of layer parameters such that a pre-defined set of training images is correctly categorized through processing by the neural network. During this training procedure, the parameters are altered, and the neural network is tested for its accuracy. The exact alteration of the parameters is determined by a loss function, which quantifies the accuracy and desirable features of parameters of the neural network and its associated accuracy on the training images. In an example, the loss function includes the square of the error of the resulting category predicted by the neural network in relation to each of the parameters; the resulting gradient of parameter influence is followed to minimize the squared error, constituting training of the neural network. The neural network may further be modified, such as having its parameters be converted into integers for purposes of performance optimization. The training process may be conducted on the instrument's microprocessor or can be more efficiently done on external computers.

The photographs used by the neural network may be algorithmically processed beforehand. Various aspects of signal recognition can be improved through the associated algorithmic techniques. In the disclosed embodiment, a matrix of weights is applied to the picture, affecting the colors and brightness of the pixels, along with a threshold to reduce noise.

Following picture acquisition and the algorithmic steps, the resulting signal is processed by a neural network to generate categorical results. In the disclosed embodiment, positive and negative categories are used; a neural network will return the result of a picture, which does not rely on a threshold brightness as would often be the case with purely analog signal data.

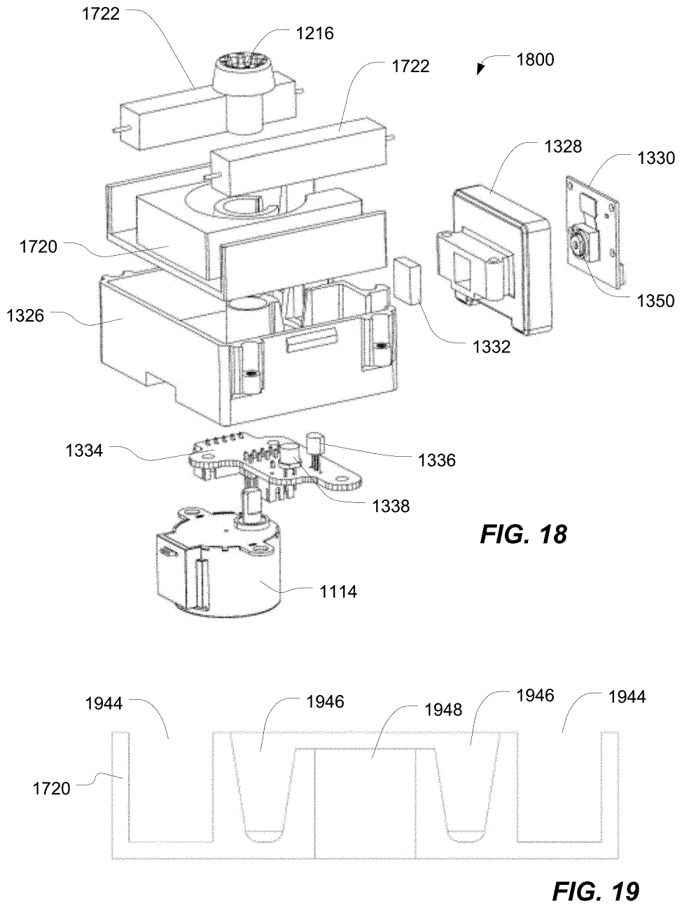

FIG. 24 includes a further method 2400 for detecting and measuring signals resulting from reactions within a reaction chamber. For example, as illustrated at block 2402, the system can acquire image data. In particular, a cartridge can be rotated, as illustrated at block 2404, and a particular reaction chamber can be centered in front of the camera or imaging device and over an illumination source, as illustrated at block 2406. The camera can take an image, as illustrated at block 2408, that is further processed, optionally, using various methods.

In an example, the system can load a neural network module, as illustrated at block 2410. The captured image of the reaction chamber can be fed to the neural network, as illustrated at block 2412. The neural network can then give a signal category. For example, the neural network may identify that a bubble is disposed within the reaction chamber or that liquid is asymmetrically disposed within the reaction chamber or that, preferably, liquid is symmetrically disposed at the bottom of the reaction chamber.

A separate module can flatten the image with weights, as illustrated at block 2414, and calculate analog signals, as illustrated at block 2416. This analog signal in combination with the category determined by the neural network can then be utilized to provide a result, as illustrated at block 2418. The final results can then be displayed, as illustrated at block 2420. For example, the overall results can be displayed, as illustrated at block 2422, along with the category determined by the neural network, as illustrated at block 2424. Alternatively, a neural network can be used to detect signals or quantify a signal.

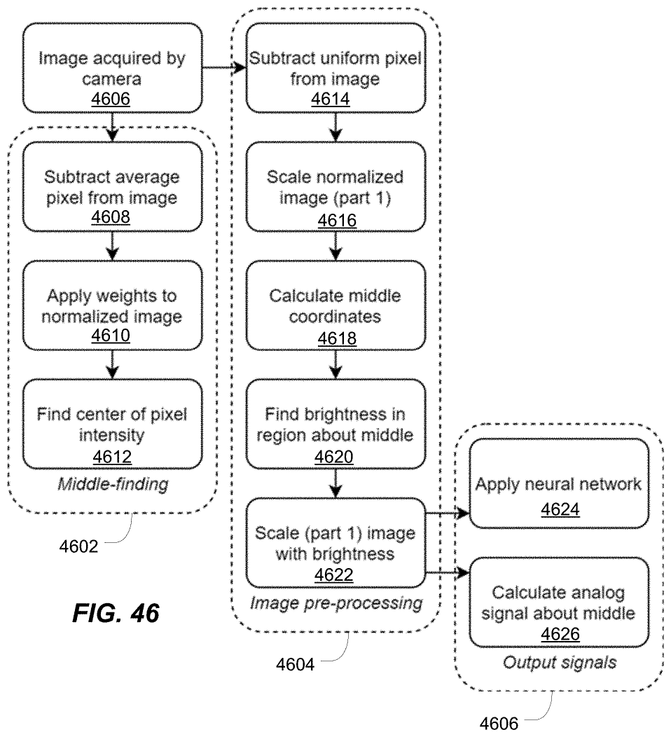

In an embodiment, the signals from a reaction may be analyzed with an image processing sequence, including a middle-finding algorithm 4602, a pre-processing algorithm 4604, and an output signal algorithm 4606, as illustrated in FIG. 46. The image processing sequence may provide data for the rotation of the cartridge, the classification of signals, or the collection of photographic data.

In an example, an image is acquired by a camera, as illustrated at block 4606. The image may be fed into a middle-finding algorithm 4602. The middle-finding algorithm 4602 normalizes the image by subtracting the average pixel uniformly across the image, as illustrated at block 4608. The normalized image may have weights applied to it for improving clarity, as illustrated at block 4610. A calculation may be conducted to find the coordinate center of pixel intensity, as illustrated at block 4612, and this center constitutes a middle coordinate that may be used to rotate the cartridge, for example to position a reaction chamber directly above a light emitting diode.

An image acquired by a camera may be fed into a pre-processing algorithm 4604 for modifying the image. For example, the image may be modified to compensate for low power output from a light emitting diode. The image may have a uniform pixel subtracted from each pixel in the image, as illustrated at block 4614. The normalized image may be scaled a first time , as illustrated at block 4616. The coordinate middle of the image may be calculated, as illustrated at block 4618. Based on the coordinate middle, a region of pixels about the middle may be used to calculate a brightness, as illustrated at block 4620. Based on this brightness, the first scaled image may be scaled again with a function of the brightness, as illustrated at block 4622. The resulting modified image may then be used for further processing.

A modified or unmodified image may be used for calculation of signals in an output signal algorithm 4606. In an example, a neural network is applied to the image to derive categorical signals, as illustrated at block 4624. In another example, an analog signal may be calculated by finding the average pixel intensity about the coordinate middle of an image, as illustrated at block 4626. The image may further be displayed in real time to the user on a display, such as a touch screen.

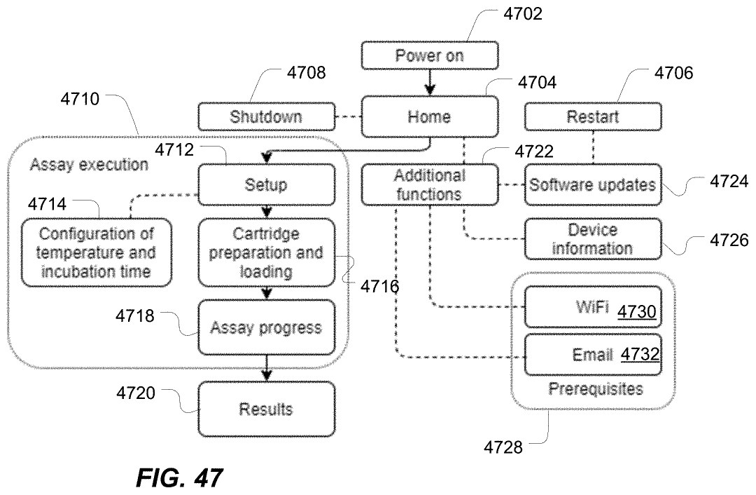

In another exemplary embodiment of an instrument, instrument functions may be available from a plurality of screens on a user interface, such as a touch screen. As illustrated in the diagram of FIG. 47, when an instrument is powered on 4702, a home screen 4704 may be shown. From the home screen, the instrument may be shut down 4708, or other screens may be accessed. An assay execution protocol 4710 may be entered by going to a setup screen 4712, which may include instructions on operation of the instrument. Instrument parameters, such as the temperature profile, may be configured from a configuration element 4714. The cartridge may be prepared and loaded into the instrument while a user is on the setup screen 4716. The setup screen may then lead to an assay progress screen 4718, which may include real-time data.

Following the completion of an assay, a results screen 4720 may be shown, including results determined by the instrument. A screen with additional functions 4722 may be accessed from the home screen 4704, including a software updates screen 4724. The software updates screen may be used to obtain software updates for the instrument, which may require restarting the device 4706. A screen with device information 4726 may be accessed. Additional screens may be accessed, which include prerequisite information 4778. For example, a Wi-Fi screen 4730 may be accessed to configure internet connectivity. An email screen 4732 may be accessed to set an email address to which results may be sent to.

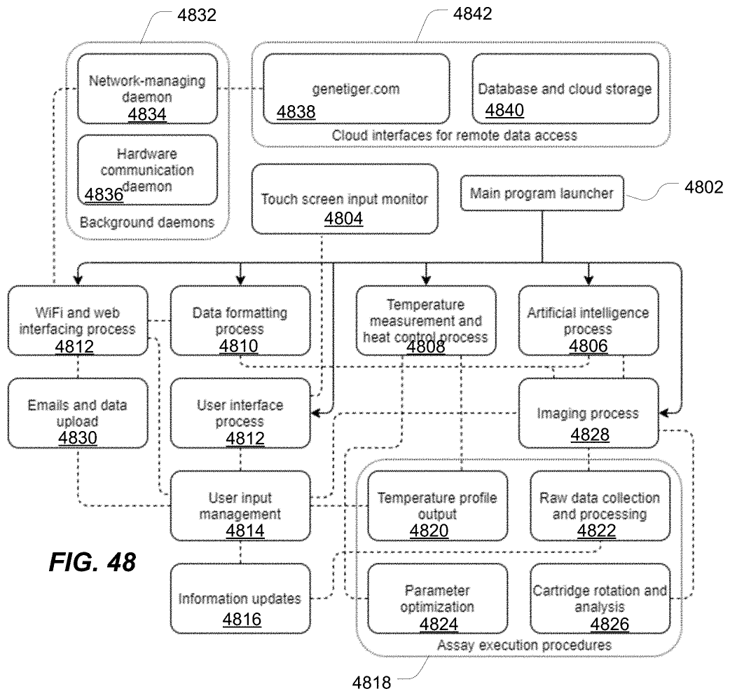

In an example, the software architecture of an instrument may include a plurality of elements, as illustrated in FIG. 48. A main program launcher 4802 may be used to initiate a series of programs that control various aspects of instrument functionality. A web process 4812 may be initiated, which includes functions for internet connectivity and data transfer. The web process 4812 may interact with background daemons 4832 which may control hardware communications 4836 and manage Wi-Fi network connectivity 4834. These daemons may be used by the web process 4812 to interact with cloud interfaces 4842, such as a website 4838 and database 4840 for data collection and storage. Additionally, the web process 4812 may interact with other elements for acquiring data and commands. For example, an emails and data upload element 4830 may be used for data manipulation and sending.

A data formatting process 4810 may be initiated, which may acquire data from other elements, and process it into other forms, such as charts and figures. A user interface process 4812 may be initiated, which may interact with a touch screen input monitor 4804 to determine user inputs. A user input management element 4814 may then process inputs to determine functions to be executed by other elements. Additionally, the user input management element 4814 may receive information from other elements for transfer to other elements. An information update element 4816 may be used, for example, to collect data from other elements.

A temperature control process 4808 may be initiated, which may include functions for the control of temperatures in the measurement module. The temperature control process 4808 may communicate with a parameter optimization process 4824 to improve heating accuracy and performance. The output of temperatures profile output 4820 and parameter optimization elements 4824 are part of assay execution procedures 4818, which are used for the execution of chemical reactions in the reaction compartments. The assay execution procedures 4818 also include the collection of raw signal data process 4822 and the rotation of a cartridge process 4826.

An artificial intelligence process 4806 may also be initiated, which may conduct neural network inference on raw data and communicate with other elements for the transfer of output data. The artificial intelligence process 4806 may acquire images from an initiated imaging process 4828, which may interface with a raw data collection module. The imaging process 4828 may also provide input to a cartridge rotation element to rotate the cartridge.

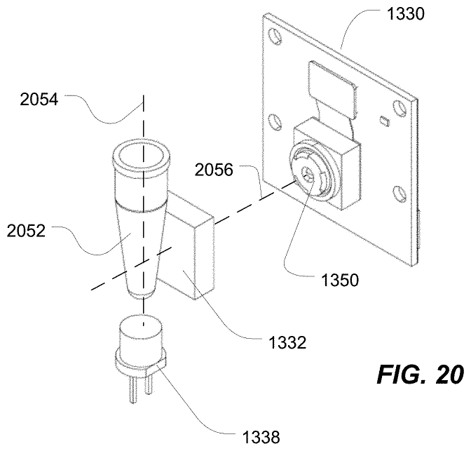

A neural network can be trained to identify less than optimal conditions for measuring color or fluorescence associated with the reaction or, optionally, determine the presence of a signal. FIG. 25 illustrates a block flow diagram of an example method 2500 for generating a neural network. For example, control data is acquired, as illustrated at block 2504. Example control data can include images in which the liquid sample is symmetrically disposed at the bottom of a reaction chamber. Alternatively, the data can include images of various bubbles and asymmetric distribution of liquid samples within a reaction chamber. As illustrated at block 2506, the data is classified into various categories.

As part of the development of the neural network, as illustrated at block 2508, a neural network structure can be selected, as illustrated at block 2510. The data is fed into the neural network structure, as illustrated at block 2512, and parameters are adjusted, as illustrated at block 2514, to train the neural network. As a result, an optimized neural network is provided, as illustrated at block 2516. Such a neural network can be used by the instrument, as illustrated at block 2518, to categorize samples and improve measurement by the instrument.

In an example, a network includes a layer which flattens three-dimensional images into two-dimensional grayscale images prior to additional convolutional layers. In another example, a network which has been pre-trained to categorize various objects (such as letters and animals) may be used as a starting basis for the training of a new network; the weights of the network are already optimized for categorizing some objects, but are modified during the process of training to also categorize sample data. In a further example, the loss function of the neural network (by which parameters are modified) may involve calculating the categorical cross-entropy of the categorization accuracy of the network on sample data.

In an additional example, the loss function of the neural network may involve calculating the mean-squared-error of the categorization accuracy of the network. In another example, an EfficientNet may be used such that the parameters of the network are optimized for the reduction of complexity and increase in accuracy after training In a further example, a MobileNet may be trained with sample data for data categorization. In another example, a network training process may be chosen that parameters which do not have a substantial effect on the outcome of the network are removed from the network at each layer. In another example, a larger network structure is chosen, such that after training the network may be converted to a smaller network without substantial reduction in accuracy.

In a further example, the weights of the network may be initiated with higher precision, and after training are rounded to be of lower precision (thus reducing the memory footprint of the network) while insubstantially affecting its accuracy. In another example, various computational platforms are used for the training of neural networks; Tensorflow, Keras, PyTorch, and other libraries for data manipulation such as Numpy, OpenCV, and Matplotlib may be used in Python for conducting training

With a neural network structure chosen, sample data is divided into groups which are fed into the neural network. The accuracy of the neural network and the loss is calculated, which is then used to modify the parameters of the neural network. Optimizers may be used to do so as well; for example, an Adam optimizer may be used, or an SGD (stochastic gradient descent) optimizer may be used. Groups may be used multiple times to improve the performance of the neural network on sample data. For example, a neural network may undergo 200 rounds of training, such that all sample data is used at least three times for improving network performance.

Once training is complete, the neural network is validated on separate sample data which was not used in the training process. The neural network may also be converted to be simpler (reducing its size) with subsequent validation to ensure performance. The neural network is then deployed to devices, which use it for categorizing real sample data.

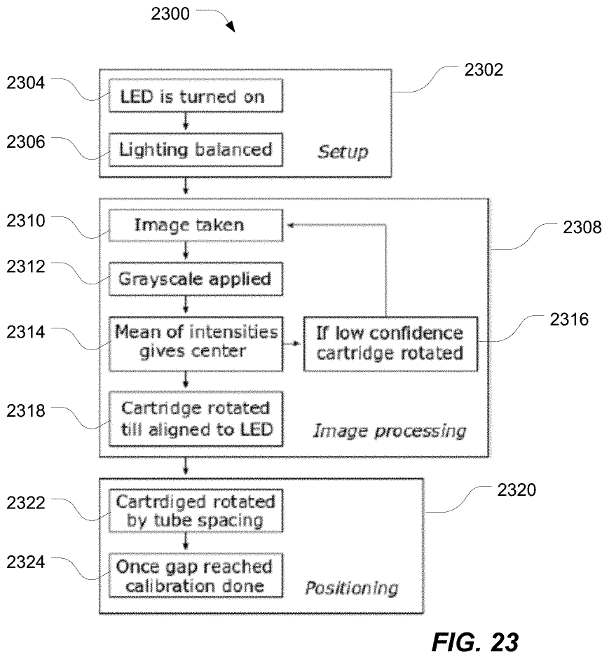

The processing of images for purposes of calibration and analysis is shown in an exemplary process in FIG. 28. For calibration images 2800, an off-center reaction compartment image 2801 and a centered reaction compartment image 2802 are analyzed through center calculation 2803, involving the mean of pixel intensities of the images, to generate coordinate centers 2804, which are then used for rotating the cartridge 400 until a reaction chamber 410 is centered in the image.

For analysis images 2805, a negative signal image 2806 and a positive signal image 2806 are analyzed through neural network processing 2807, generating categorical confidences 2808. These categorical confidences 2808 are processed in terms of categorical output 2809 to give final results 2810.

The application of a neural network to reaction compartments can resolve a number of issues, for example, bubble presence, extra drops, light noise, or evaporated volumes. In the case of bubbles, a neural network trained with samples also containing bubbles can discern the correct signal, irrespective of the amount of diffracted light due to the position of the bubble. Likewise, training data containing light noise or inconsistent volumes can be used to train a neural network, allowing it to correctly process samples having such features. This versatility is highly desirable, as standard protocols for amplification-based diagnostics conducted in qPCR machines require very high-quality samples, the preparation of which may involve pipetting, centrifugation, and filtration among other time-consuming steps.

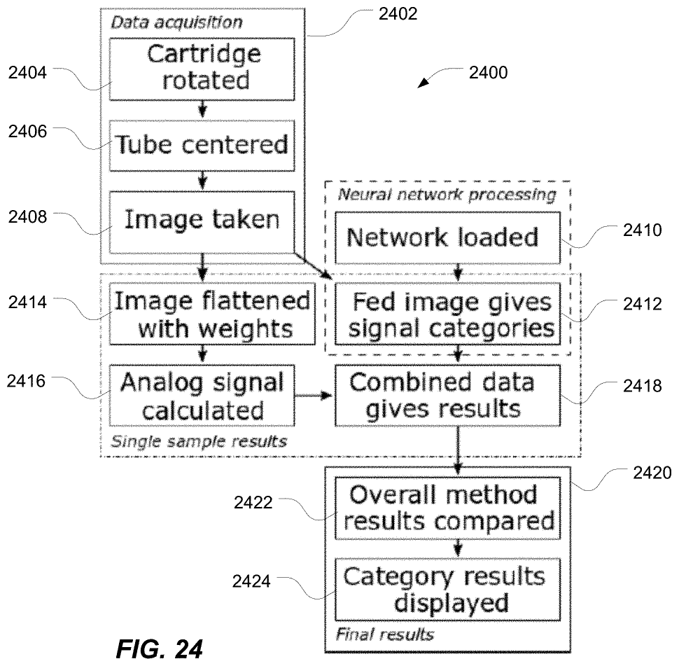

Examples of discrepancies in signals are shown in FIG. 29. All images of the reaction compartments shown in the figure have incorrectly identified signals through algorithmic computation, but correctly identified signals through processing by a neural network. An image of a reaction compartment with drops of liquid on the sides 2900, along with images 2901 and 2903 of reaction compartments having debris, and an image of a reaction compartment having a drop of liquid above the surface 2902 are positive samples which are incorrectly determined to be negative through pixel color averaging. An image of a negative sample with glare near the bottom of the reaction compartment 2904 and an image with high light refraction along the surface of a negative sample 2905 are incorrectly determined to be positive through algorithmic computation, but correctly determined to be negative through processing by a neural network.

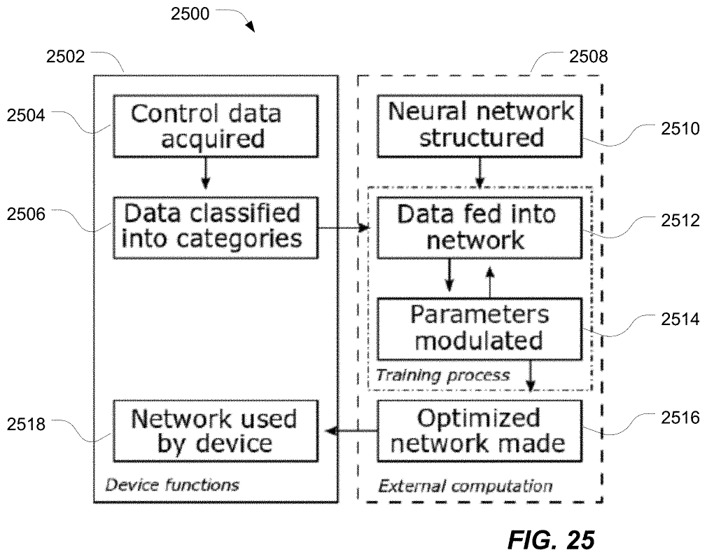

The data obtained by the instrument may be plotted, as shown in FIG. 30. High-quality samples can be visually identified as positives by continuous analog signals 3000 and are categorically determined to be such with signals from a neural network 3001.

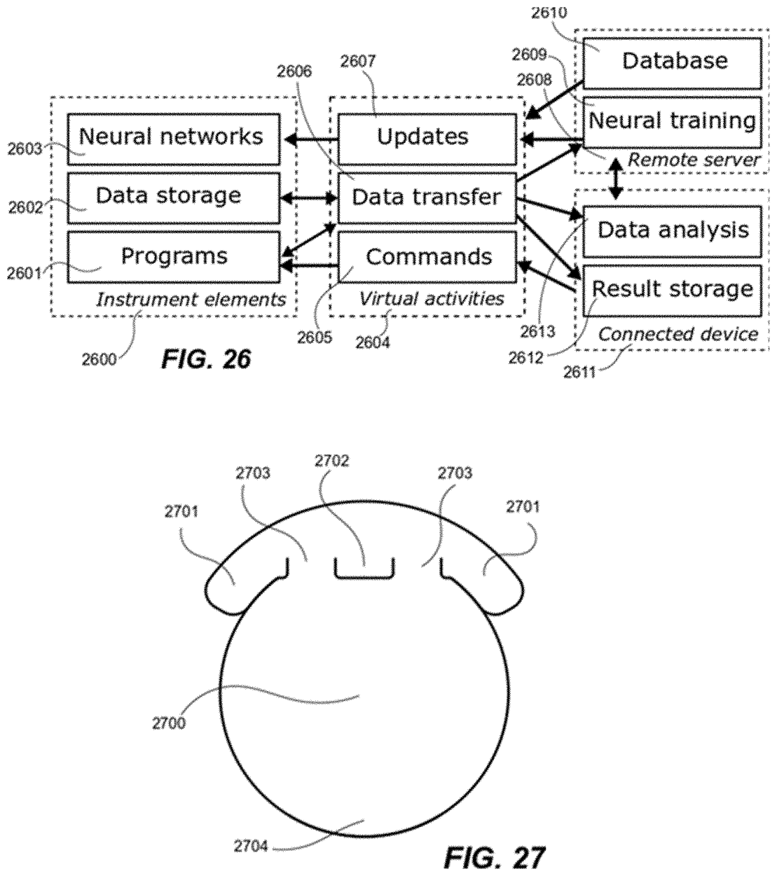

The data obtained by the instrument, whether through analog algorithms or a neural network, is unitless and may be numerically processed to determine final outputs. Summation of collected signals can provide metrics from which final boolean data may be determined with thresholds. Exemplary analog and neural data is shown in FIG. 31. In some cases, summed analog data 3100 does not clearly discern positives and negatives. In these cases, summed neural data 3101 may provide clearer distinctions. In an example, summed outputs from a neural network are equal to 35 for a positive signal, and 0 for a negative signal. With a threshold of 15, both signals can be reliably classified.

A threshold for the summed neural network results 3101 may be used to determine the final signal For example, if there are at least 3 positive readings by a neural network for a sample, then the sample may be considered a positive. A limited selection of neural network results may also be used for final result calculation. In an example, only the most recent 5 outputs by the neural network for a sample are used for determining the final result. This limited selection can be helpful if a positive signal is only generated after some time, such as that shown in plots 3000 and 3001. This is the case for loop-mediated isothermal amplification (LAMP), where the chemical reaction requires prolonged incubation for fluorophores to be released.

In an example, the operation begins with the user obtaining a liquid sample. In one example, the liquid can be water, which may be contaminated with bacteria (which may be the target of a nucleic-acid amplification diagnostic). In other examples, liquid samples can be derived from body fluids, such as urine, blood, or mucus, or from swabs. The user can fill a syringe with the liquid, after which the syringe is secured to a cartridge, and depressed to transfer the liquid into the cartridge. The cartridge can be placed into the instrument by opening the cover and placing the cartridge into the module. The orientation of the cartridge does not matter in the placement; the calibration does not depend on any initial position.

The user can initiate a test by operating the graphical user interface of the instrument, for example, pressing a single button begins the test. The instrument can calibrate the cartridge and begin continuously imaging the cartridge while incubating the reaction chamber. Upon completion of the test, the results from the neural network and any associated algorithmic steps (such as comparing the signals from different reaction chamber) are processed to give a final result. In the case of diagnostic evaluation, a positive or negative output is displayed.

The incubation time and data analysis is preprogrammed into the instrument for a given test; different cartridges may be used by the instrument. For example, diagnostics for coronaviruses, e.g., COVID-19, chlamydia, dengue fever, and gonorrhea may be integrated into different cartridges. Different cartridges may differ in the number of reaction compartments and the chemical reagents therein. Different tests (requiring different cartridges) may differ in the incubation temperature, incubation time, algorithmic computations, and the applied neural network for signal analysis.

A database of data and neural networks can be maintained for the purposes of later application in the instrument. A different neural network can be prepared for each different test or each cartridge type. Neural networks may be improved with more data collected from multiple devices; subsequent training on such data can fine-tune parameters. As the neural networks, optionally, can be trained to work for only one given type of chemical reaction, the additional data improves the robustness of the neural networks for application by the instrument.

Optionally, the instrument can be remotely accessed; data may be accessed from other devices, while software updates may be downloaded as well. The augmented functions are intended for usage by untrained users; operation of the instrument is restricted to handling of the cartridge and interaction with the graphical user interface.

Embodiments of the present instrument provide various technical advantages over conventional systems. For example, embodiments of the present system utilize limited setup procedures. Further, embodiments of the present system do not utilize micropipetting, avoiding errors associated therewith. In addition, embodiment of the present system are portable and have low power consumption. For example, embodiments can utilize isothermal reactions that utilize less power than qPCR reactions. Embodiments utilizing cameras provide particular advantages over analog measurement of light signals.

Embodiments of the present instrument show particular promise when used with isothermal chemistries, for example, loop-mediated isothermal amplification (LAMP). Recent advancements allow for efficient amplification to take place at a single incubation temperature, termed loop-mediated isothermal amplification (LAMP) with one-step strand displacement (OSD). LAMP can replace conventional diagnostics that have become standards in remote applications. For example, the determination of bacterial presence in water has traditionally been facilitated by culturing and subsequent detection of bacteria-specific substrates.

LAMP can be used to compare RNA markers that can be used to distinguish between viable and non-viable coliform bacteria and E. Coli. In another example, LAMP can be used for diagnosing diseases, such as through detection of Neisseria gonorrhoeae and Chlamydia trachomatis or viruses, such as Zika, COVID-19, SARS, MERS, among others. In yet another example, LAMP can be used detecting mismatch methyl groups on DNA for epigenetic diagnostics.

Mechanically, LAMP-OSD can be conducted with incubation at a given temperature, during which four nucleic acid primers bind to six consecutive target regions and a strand displacement polymerase extends the primers and initiates strand displacement synthesis to form concatemerized amplicons with loops between the target regions. Amplicon accumulation can be measured by nucleic acid dyes that create a colorimetric or fluorescent signal. This process is augmented by OSD probes, which can ensure specificity and are bound to quenched fluorophores, which are released upon synthesis of DNA, thus generating a fluorescent product which is imaged by the instrument. The OSD probe has a single-strand region complementary to the target DNA sequence, ensuring that the quenched fluorophore is only released when the OSD probe is bound to the target DNA sequence.

The instrument is, in an exemplary embodiment, designed to incubate the cartridge for prolonged periods of time with optional changes in temperature to facilitate LAMP reactions. The cartridge, having been designed for ease-of-use by untrained users, is imaged by the measurement module, with full data analysis conducted by the device giving endpoint results. This streamlined process automates procedures which are ordinarily conducted by trained lab technicians and substantially simplifies the steps for an ordinary user unfamiliar with the reaction chemistry to benefit from results generated by the instrument. For example, in the detection of bacteria in water, an untrained user may analyze water samples by using the instrument, thus conducting LAMP, and receiving information on the presence of absence of bacteria such as E. Coli. Users benefit from the simplicity of the actions necessary on their behalf, and the robust processes which are conducted by the instrument.

### EXAMPLES

LAMP Reagents Citations

Reference is made to the following publications for details regarding reagents.

Bhadra, Sanchita, et al. “Real-Time Sequence-Validated Loop-Mediated Isothermal Amplification Assays for Detection of Middle East Respiratory Syndrome Coronavirus (MERS-CoV).” Plos One, vol. 10, no. 4, 2015, doi:10.1371/journal.pone.0123126.

Jiang, Yu (Sherry), et al. “Real-Time Detection of Isothermal Amplification Reactions with Thermostable Catalytic Hairpin Assembly.” Journal of the American Chemical Society, vol. 135, no. 20, 2013, pp. 7430-7433., doi:10.1021/ja4023978.

### Example 1

### E. Coli LAMP with Incubation and Manual Sample Preparation

Reagents for the execution of isothermal nucleic acid amplification for the detection of live E. Coli in environmental water samples include primers, buffers, and other formulations. A water sample is first obtained in a 100-milliliter syringe. A 45-micron filter is then attached to the syringe, and the water is pushed through the filter, leaving bacteria on the filter. A second, separate syringe is then prepared, which contains a culturing buffer. The filter is then removed from the first syringe and attached to the second in reverse fashion. The second syringe is then depressed, and the culturing buffer washes out bacteria from the filter into a culturing vesicle.

The culturing buffer contains media supporting the growth of E. Coli (such as fetal bovine serum) and sodium thiosulphate for the salt precipitation of chlorine out of solution, enhancing the growth rate of the bacteria if they have been stressed by chlorine prior (such as in water treatment facilities). The bacteria are cultured at 37 degrees Celsius for 2 hours, at which point the sample is split into two. Half of the sample undergoes an additional 2 hours of incubation, while the other half rests on ice. Following the completion of incubation, the samples are transferred to sample preparation tubes.

Each sample preparation tube contains reagents prior to the depositing of bacteria-containing media. These reagents comprise deoxynucleoside triphosphates for incorporation into amplicons during amplification, primers for flanking the desired target for sequence- specific identification of E. Coli, magnesium chloride for use in nucleotide incorporation, betaine for the improvement of amplification of sequences rich in guanine and cytosine, one-step strand displacement reagents for the sequence-specific nicking of polymerase landing sites, Bst polymerase (a strand-displacing polymerase which may function without thermal denaturation of double-stranded nucleic acids), nuclease-free water, and reverse transcriptase for the conversion of target RNA sequences into DNA. Fast deterioration of certain RNA sequences after bacterial death is used to determine if any present bacteria are alive.

The samples are each mixed with the reagents in their respective sample preparation tubes, and a 1 milliliter syringe is used to transfer each sample from its sample preparation tube into a sterile cartridge; a syringe is attached to the insertion port of the cartridge and depressed to transfer reagents into appropriate reaction compartments. The two cartridges are then placed into separate devices wherein the isothermal amplification assay is executed. The assay is conducted at 60 degrees Celsius for 90 minutes, during which each cartridge is imaged. Upon the end of the assay, the device calculates the signal data for each microtube in the cartridge and aggregates the data into a final determination of signal presence and a quantitative metric for the value of the signal Comparison of the signals from the two cartridges identifies the presence of E. Coli and if they are alive; if the signal from the second cartridge is less than that of the first, the bacteria are dead. If neither cartridge is found to have a signal, there are no bacteria present in the sample. Otherwise, living bacteria are present.

### Example 2

### Coliform LAMP with No Incubation and Predeposited Liquid Reagents in Cartridge

Detection of Coliforms through isothermal amplification without reference to them being alive or dead does not utilize prior incubation and is conducted with pre-deposited reagents in a cartridge. If few bacteria are assumed to present in a desired water sample, a 100-milliliter water sample is obtained in a syringe, and a 45-micron filter is attached. The sample is depressed through the filter such that any present bacteria remain on the filter. The filter is then removed and reversely attached to a separate syringe containing water or an isothermal amplification buffer. The buffer is then passed through the filter, flushing out any bacteria on the filter into a designated sample receptacle. A 1 milliliter sample syringe is then filled with the eluted sample. In the case that many bacteria are assumed to be present in a desired water sample, the sample syringe is immediately filled with 1 milliliter of the water sample, without filtration of a larger sample.

A cartridge is obtained, containing isothermal amplification reagents. These reagents include deoxynucleoside triphosphates, primers for flanking the desired target for sequence-specific identification of Coliforms, magnesium chloride, betaine, one-step strand displacement reagents, and Bst polymerase. The reagents are in the format of a viscous liquid, the viscosity of which decreases during incubation such that the convection of fluids in each reaction chamber mixes the sample and reagents sufficiently well for amplification to take place. The sample-containing syringe is attached to the cartridge and depressed, distributing the sample among the reagent-containing reaction chambers.

The cartridge is resealed and placed into a device. The assay is initiated, and incubation takes place at 65 degrees Celsius for 60 minutes, during which the cartridge is imaged. Upon the end of the assay, data from the amplification is aggregated to give a minimum probable number count for the bacteria present in the sample. This number corresponds to the number of reaction chambers which fluoresce at the end of the assay; each fluorescent chamber must contain at least one bacteria for a signal to be detected.

### Example 3

### Generic LAMP with Lyophilized Reagents

For the detection of target nucleic acid sequences, such as those specific to Gonorrhea, Dengue Virus, Chlamydia, and various mosquitoes such as Aedes Aegypti, lyophilized reagents are predeposited in the reaction chambers of cartridges. A sample is obtained and undergoes preparation as needed prior to insertion into a cartridge. For mosquitoes, particulate matter (such as a leg or wing) is ground and mixed with a lysis buffer compatible with isothermal amplification. For human pathogens, surface swabs are washed with an elution buffer compatible with isothermal amplification. For example, a NEB buffer with Tris-HCL, KCL, (NH4)2SO4, MgSO4, and Tween 20 may be used. The buffer may contain lysing reagents to ensure that target nucleic acids are released from inside cellular structures.

Cartridges specific to each target analyte contain generic isothermal amplification reagents (deoxynucleoside triphosphates, magnesium chloride, betaine, one-step strand displacement reagents, and Bst polymerase) while differing in the primers present. Primers are chosen to flank designated targets. Reverse transcriptase may be present if a target is identified by RNAs. The reagents are lyophilized prior to deposition in reaction compartments of the cartridges.

Each reaction compartment may contain different reagents; negative control reaction compartments may contain no reagents whatsoever. Screening for the presence of multiple analytes may be done by placing different reagents into different reaction compartments, such as for the detection of Chlamydia and Gonorrhea in a single cartridge.

The sample, after undergoing necessary preparation, is deposited in the cartridges via an attached syringe, distributing the sample among the reaction tubes. The liquid sample dissolves the lyophilized reagents. The cartridge is placed into a device and an appropriate incubation protocol is conducted for isothermal amplification to take place. For example, incubation may be conducted at 65 degrees Celsius for 75 minutes. Imaging is conducted during the assay, and upon completion data is aggregated to give final results for the presence of target analytes.

Example 4 and Example 5 utilize the reagents and primers described in Bhadra, Sanchita, et al. “High-surety isothermal amplification and detection of SARS-CoV-2, including with crude enzyme.” July 2020, doi.org/10.1101/2020.04.13.039941.

### Example 4

### COVID-19 Testing

An instrument is used to detect SARS-COV-2 in human saliva with a reusable cartridge. A sample of saliva is obtained by the user and heated to reduce enzymatic activity. 5 microliters of the heat-inactivated saliva is mixed with reagents, including primers and polymerases, for the execution of a nucleic acid amplification reaction. 25 microliters of the mixture are deposited in a microtube. Separate microtubes containing negative and positive controls are prepared. The negative control, positive control, and sample microtubes are inserted into three openings in a reusable cartridge, with remaining openings filled by blank microtubes.

The instrument is powered on. Once the home screen has been displayed, a button is pressed to reach the setup screen. The cartridge is placed into the measurement module and the cover is closed. A temperature profile is configured to include incubation at 65 degrees Celsius for 80 minutes with a 10-minute terminal cooling step. A button is pressed to begin the assay, and real-time progress is shown on screen.

The instrument rotates the cartridge and illuminates each reaction chamber successively, collecting images with a camera through a set of fluorescence filters. In an example, a 3-watt blue light emitting diode with a peak wavelength of 460 nanometers illuminates reaction chambers, and the camera views through a set of 5 dichroic filters functioning to exclude wavelengths below 490 nanometers. The window is made of a thermostable and clear polycarbonate. Images are collected with a 0.25 second exposure time. The images are processed, and inference is conducted with a neural network to determine positive and negative signals.

At the end of the temperature profile, the results from the neural network are aggregated and final results are determined. These results are shown on screen to the user, and an email with plots of the data is sent to a predetermined email address. If the negative and positive controls have led to negative and positive results, respectively, the sample result is considered valid.

### Example 5

### COVID-19 Testing

An instrument is used to detect SARS-COV-2 in human saliva with a reusable cartridge. A sample of saliva is obtained by the user by passive drooling into a 15 mL conical tube, which contains a buffer and reagents that may serve to reduce enzymatic activity in the saliva. The conical tube is then heated at 65 degrees Celsius for 15 minutes to further reduce enzymatic activity. 5 microliters of the heat-inactivated saliva is mixed with reagents, including primers and polymerases, for the execution of a nucleic acid amplification reaction. 25 microliters of the mixture are deposited in a microtube.

Separate microtubes containing negative and positive controls are prepared. For example, the negative control may include primers but exclude enzymes needed for amplification. The positive control may include primers and enzymes for the amplification of sequences expected in all saliva samples, for example that of human GAPDH. The negative control, positive control, and sample microtubes are inserted into three openings in a reusable cartridge, with remaining openings filled by blank microtubes.

The instrument is powered on. Once the home screen has been displayed, a button is pressed to reach the setup screen. The cartridge is placed into the measurement module and the cover is closed. A temperature profile is configured to include incubation at 65 degrees Celsius for 80 minutes with a 10-minute terminal cooling step. A button is pressed to begin the assay, and real-time progress is shown on screen.

The instrument rotates the cartridge and illuminates each reaction chamber successively, collecting images with a camera through a set of fluorescence filters. In an example, a 3-watt blue light emitting diode with a peak wavelength of 460 nanometers illuminates reaction chambers, and the camera views through a set of 5 dichroic filters functioning to exclude wavelengths below 490 nanometers. The window is made of a thermostable and clear polycarbonate. Images are collected with a 0.25 second exposure time. The images are processed, and inference is conducted with a neural network to determine positive and negative signals.

At the end of the temperature profile, the results from the neural network are aggregated and final results are determined. These results are shown on screen to the user, and an email with plots of the data is sent to a predetermined email address. If the negative and positive controls have led to negative and positive results, respectively, the sample result is considered valid.

Example 6

### Neural Network Training

A neural network is trained on sample data obtained by a fleet of devices. The sample data is obtained by the repeated imaging of cartridges once definitive signals have been achieved. The neural network structure is determined prior to training, and the performance is validated after training on separate data. Subsequently, the neural network is used by devices for signal categorization; additional data is used to cyclically improve the performance of the network.

In an example, fluorescein-containing buffers are deposited into half of the reaction of chambers of 30 cartridges, with the remaining half filled with water. The cartridges are then placed successively in several devices, where they undergo 100 rounds of imaging at a temperature of 65 degrees Celsius. 18,000 sample data points are thus obtained, and their signals are known beforehand (fluorescein being a positive signal). The data is categorized, and some data is reserved for validation of the neural network after training

In another example, reagents for the detection of E. Coli are deposited into cartridges. Positive samples containing template DNA specific to the primers are deposited into half of the reaction chambers of 20 cartridges, while samples lacking positive templates (but including all remaining reagents) are deposited into the other half. The cartridges are placed in devices and undergo 200 rounds of imaging, generating 24,000 data points. The categories of the samples are known as only control templates are used.

Additionally, samples may be manually sorted through for the identification of errorsome signals; for example, if a reaction compartment contains a bubble that data point will be categorized as having an error, or more specifically a bubble. The same may be done for the identification of debris, turbidity, and off-centeredness (which may occur due to errors in the centering of the microtube above the excitation light source).

A neural network structure is chosen prior to training For example, a network consisting of several three-dimensional convolution layers converging to a two-category output may be used with the starting weights determined randomly.

In another example, a network includes a layer which flattens three-dimensional images into two-dimensional grayscale images prior to additional convolutional layers.

In another example, a network which has been pre-trained to categorize various objects (such as letters and animals) may be used as a starting basis for the training of a new network; the weights of the network are already optimized for categorizing some objects, but are modified during the process of training to also categorize sample data.

In another example, the loss function of the neural network (by which parameters are modified) may involve calculating the categorical cross-entropy of the categorization accuracy of the network on sample data.

In another example, the loss function of the neural network may involve calculating the mean-squared-error of the categorization accuracy of the network.

In another example, an EfficientNet may be used such that the parameters of the network are optimized for the reduction of complexity and increase in accuracy after training

In another example, a MobileNet may be trained with sample data for data categorization.

In another example, a network training process may be chosen that parameters which do not have a substantial effect on the outcome of the network are removed from the network at each layer.

In another example, a larger network structure is chosen, such that after training the network may be converted to a smaller network without substantial reduction in accuracy.

In another example, the weights of the network may be initiated with higher precision, and after training are rounded to be of lower precision (thus reducing the memory footprint of the network) while insubstantially affecting its accuracy.

In another example, various computational platforms are used for the training of neural networks; Tensorflow, Keras, PyTorch, and other libraries for data manipulation such as Numpy, OpenCV, and Matplotlib may be used in Python for conducting training.

With a neural network structure chosen, sample data is divided into groups which are fed into the neural network. The accuracy of the neural network and the loss is calculated, which is then used to modify the parameters of the neural network. Optimizers may be used to do so as well; for example, an Adam optimizer may be used, or an SGD (stochastic gradient descent) optimizer may be used. Groups may be used multiple times to improve the performance of the neural network on sample data. For example, a neural network may undergo 200 rounds of training, such that all sample data is used at least three times for improving network performance.

Once training is complete, the neural network is validated on separate sample data which was not used in the training process. The neural network may also be converted to be simpler (reducing its size) with subsequent validation to ensure performance. The neural network is then deployed to devices, which use it for categorizing real sample data.

### Example 7

### Cartridge

In an example, a cartridge containing six reaction chambers is manufactured out of a thermostable resin through digital light processing. The reaction chambers are positioned at a radius of 24 mm from the insertion port, which is structured to have a male luer tip. Additionally, the reaction chambers are repeated at regular intervals of 45 degrees, with two reaction chambers omitted to form a gap by which the cartridge position may be calibrated in the device.

In another example, the nozzles in fluid communication with the insertion port protrude 12 mm into the reaction chambers. The reaction chambers may comprise transparent microtubes with volumes of 250 microliters, having a flanged opening such that the flange (upon insertion of the microtube into the cartridge during assembly) snaps into a designated groove in the cartridge, with the nozzle ending at a height in the microtube corresponding to a filled volume of 50 microliters. The net volume of the channels in the cartridge may comprise 1.5 milliliters, configured such that the cross-sectional area of the channels as followed by a fluid particle moving from the insertion port to the nozzle and into the reaction chambers is decreasing, accelerating the flow. In another example, the cross-sectional area of the nozzle opening is 0.785 square millimeters

In an auxiliary example, a vent channel is aligned adjacent to that of the fluid-depositing nozzle such that the vent channel begins at a height corresponding to a filled volume of 75 microliters in the microtube, such that liquid in excess of 75 microliters, deposited out of the nozzle, is forced to exit through the vent channel thus restricting range of visible volume in the microtube.

### Example 8

### Device

In an example, a device is made to house a functional module and controlling electronic equipment. The device casing may be made of 304 2B steel with internal structural components made of selectively laser sintered nylon. In another example, the casing may be made of a plastic such as polylactic acid. In another example, the internal structural components may be made of a thermostable resin. The functional module may comprise an aluminum heating block to fit a cartridge. For example, the aluminum block made of 6061 aluminum may measure 60×50×15 millimeters and contain a circular groove to encompass the microtubes of the cartridge while permitting rotation of the cartridge by an underlying stepper motor.

The functional module may contain resistors placed in the aluminum block such that the resistors heat the aluminum block and through radiative emission heat the microtubes. The functional module may also comprise a light-blocking cover such that imaging of microtubes is conducted without light noise.

### Example 9

### Operation

In an example, an assay requires isothermal incubation at a temperature of 65 degrees Celsius for one hour. The device powers resistors in the functional module and monitors the temperature until oscillatory heating and cooling centers about 65 degrees Celsius. The incubation time is counted from the start of the powering of the resistors. Alternatively, the incubation time may be counted from the time a target temperature is reached.

The resistors may be ceramic resistors dissipating 20 watts of power into the incubation block. The resistors may use more or less power on average depending on the target temperature to be reached. Alternatively, a Peltier thermoelectric element may be used with 12 watts of power.

Calibration and imaging of the cartridge commences immediately once an assay is started; the calibration sequence and imaging may also be delayed until a designated temperature is reached. In an example, calibration commences immediately, requiring the normalization of the sensitivity of the camera in the functional module.

Calibration of the cartridge position is based on acquiring images from the camera and calculating the middle of any visible microtube according to a threshold. For example, if 80 percent of the viewable area by the camera is at a brightness greater than 50 percent of the capacity of each pixel, it may be concluded that an illuminated microtube is in sight of the camera. Taking the positional average of the brightness may give a horizontal coordinate the center of brightness, corresponding to the center of the visible microtube. The calibration may then require the rotation of the cartridge such that the visible microtube is positionally centered over the viewing window, corresponding to vertical alignment with an excitation light source.

The excitation light source comprises a light emitting diode emitting light in the blue spectrum, using 300 milliwatts of power. This allows for fluorescein in the microtube to fluoresce and be detected by the camera. Alternatively, a red or green light emitting diode may be used. A different excitation source may be used as well, such as a filtered light from a fluorescent bulb.

In an example with an excitation light emitting diode, the calibration sequence proceeds to an imaging sequence whereby the cartridge is rotated such that each microtube is imaged a fixed number of times. In an example, each microtube is imaged 35 times over the course of the assay incubation. For each microtube imaging iteration, the cartridge is rotated and the microtube is centered in the field of view of the camera, at which point a representative data image is taken. This iterative process continues over the course of the incubation.

### Example 10

### Data Analysis

In an example, a neural network may be trained on sample data obtained by a device from assay results. For example, 20,000 sample images may comprise a set of training data for a neural network. The sample images may be categorized, for example into positive, negative, and error signal categories. The neural network may then be trained on the sample image data through selection of a network structure and iterative improvement of network parameters for categorization of the data.

In an example of analog data calculation, images of the microtubes may be analyzed through computational means by determining an analogue signal. For example, the green component of the color data from a photograph may be isolated, and a selected region about the center of brightness of the image may be used to calculate the normalized sum of the green component, which may be represented on a scale from 0 to 255. The data is then accumulated over the course of incubation and may be plotted for each tube separately. A threshold may be applied for final signal determination, for example if a signal is above 230 a positive result may be issued, whereas if the signal is between 170 and 230 an indeterminate result may be issued.

In an example, final results are determined by summing the discrete values obtained by categorization with a neural network. For example, if 3 out of the 5 last imaging iterations of each microtube are positive, a positive result may be issued.

In a first aspect, a system includes a cartridge including a cartridge body defining an input port aligned with a central axis of the cartridge body, a plurality of channels in fluidic communication with the input port and extending radially to a plurality of reaction chamber connector; and a plurality of reaction chambers disposed at a radial distance from the central axis of the cartridge body and distributed at angles relative to the others of the plurality of reaction chambers, each reaction chamber of the plurality of reaction chambers uniquely connected to a reaction chamber connector of the plurality of reaction chamber connectors, each reaction chamber of the plurality of reaction chambers in fluid communication with the input port via a channel of the plurality of channels. The system further includes an instrument including: an incubation block configured to receive the plurality of reaction chambers; a motor and socket to connect with the cartridge; an illumination source having an illumination pathway; and a camera or optical array sensor disposed in a signal pathway intersecting the illumination pathway; wherein the motor and socket are to move each reaction chamber of the plurality of reaction chambers into the illumination pathway and the signal pathway, the camera to acquire an image of each reaction chamber, the instrument to determine a result based on the acquired image.

In an example of the first aspect, the imaging device includes a camera.

In another example of the first aspect and the above examples, the instrument further includes a window disposed along the signal pathway between the imaging device and the intersection of the signal pathway and the illumination pathway.

In a further example of the first aspect and the above examples, the instrument further includes a filter disposed along the signal pathway between the imaging device and the intersection of the signal pathway and the illumination pathway.

In an additional example of the first aspect and the above examples, the instrument further includes a user interface. For example, the user interface includes a touchscreen.

In another example of the first aspect and the above examples, the instrument further includes a processor to determine the result utilizing a neural network or multiple neural networks applied to the acquired image. For example, a neural network is to determine a defect state associated with the acquired image.

In a further example of the first aspect and the above examples, the instrument further includes a moveable cover configured to enclose the cartridge within the instrument.

In an additional example of the first aspect and the above examples, the instrument further includes a thermometer to detect a temperature of the incubation block.

In another example of the first aspect and the above examples, the instrument further includes control circuitry.

In a further example of the first aspect and the above examples, the plurality of reaction chambers extend parallel to the central axis.

In an additional example of the first aspect and the above examples, the cartridge body further defines an annular space and a plurality of conduits extending from the annular space to the plurality of reaction chamber connectors, each conduit of the plurality of conduits providing a gas path from a reaction chamber of the plurality of reactions chambers to the annular space.

In a further example of the first aspect and the above examples, the cartridge body further defines a plurality of nozzles, each nozzle of the plurality of nozzles connected to a channel of the plurality of channels and extending into an associated reaction chamber of the plurality of reaction chambers. For example, each nozzle of the plurality of nozzles has a tapered interior channel in communication with a channel of the plurality of channels.

In an additional example of the first aspect and the above examples, the cross-sectional area of the plurality of channels is not greater than the cross-sectional area of the input port.

In another example of the first aspect and the above examples, the plurality of channels are configured to provide fluidic resistance to flow of fluid from the input port to the plurality of reaction chambers.

In a further example of the first aspect and the above examples, the plurality of channels are configured to provide back pressure in response to fluid flow from the input port to the plurality of reaction chambers.

In an additional example of the first aspect and the above examples, a volume of the plurality of channels is not greater than 5% of a volume to be received by the plurality of reaction chambers.

In another example of the first aspect and the above examples, the cartridge body further defines an exterior shell.

In an additional example of the first aspect and the above examples, the cartridge further includes a reagent disposed in a reaction chamber of the plurality of reaction chambers. For example, the reagent is a lyophilized reagent.

In a further example of the first aspect and the above examples, the plurality of reaction chambers include between 2 and 26 reaction chambers.

In an additional example of the first aspect and the above examples, the cartridge body further defines a central stem aligned with the central axis to connect to a motor of an instrument. For example, the central stem has a gear cross-section configured to fit a complementary socket. In another example, the cartridge further includes a magnet or ferromagnetic plug disposed in the central stem.

In another example of the first aspect and the above examples, the cartridge body further defines flanges in proximity to the input port. For example, the flanges define a male luer connector.

In a further example of the first aspect and the above examples, each reaction chamber of the plurality of reaction chambers is transparent in the visible, ultraviolet, or infrared, spectrum.

In another example of the first aspect and the above examples, the cartridge body has a cylindrical configuration. For example, the cartridge body defines a gap in the cylindrical configuration when viewed from a top cross-section.

In a second aspect, an instrument includes an incubation block configured to receive a plurality of reaction chambers of a cartridge, each reaction chamber of the plurality of reaction chambers disposed at a radial distance from an axis of the cartridge and at displacement angles relative to other reaction chambers of the plurality of reaction chambers; a motor and socket to connect with a stem of the cartridge; an illumination source projecting along an illumination pathway; and an imaging device disposed in a signal pathway intersecting the illumination pathway; wherein the motor and socket are to rotate the cartridge to move each reaction chamber of the plurality of reaction chambers into the illumination pathway and the signal pathway, the imaging device to acquire an image of each reaction chamber, the instrument to determine a result based on the acquired image.

In an example of the second aspect, the imaging device includes a camera.

In another example of the second aspect and the above examples, the instrument further includes a window disposed along the signal pathway between the imaging device and the intersection of the signal pathway and the illumination pathway.

In a further example of the second aspect and the above examples, the instrument further includes a filter disposed along the signal pathway between the imaging device and the intersection of the signal pathway and the illumination pathway.

In an additional example of the second aspect and the above examples, the instrument further includes a user interface. For example, the user interface includes a touchscreen.

In another example of the second aspect and the above examples, the instrument further includes a processor to determine the result utilizing a neural network or multiple neural networks applied to the acquired image. For example, the neural network is to determine a defect state associated with the acquired image.

In a further example of the second aspect and the above examples, the instrument further includes a moveable cover configured to enclose the cartridge within the instrument.

In an additional example of the second aspect and the above examples, the instrument further includes a thermometer to detect a temperature of the incubation block.

In another example of the second aspect and the above examples, the instrument further includes control circuitry.

In a third aspect, a cartridge includes a cartridge body defining an input port aligned with a central axis of the cartridge body, a plurality of channels in fluidic communication with the input port and extending radially to a plurality of reaction chamber connectors; and a plurality of reaction chambers disposed at a radial distance from the central axis of the cartridge body and distributed at angles relative to the others of the plurality of reaction chambers, each reaction chamber of the plurality of reaction chambers uniquely connected to a reaction chamber connector of the plurality of reaction chamber connectors, each reaction chamber of the plurality of reaction chambers in fluid communication with the input port via a channel of the plurality of channels.

In an example of the third aspect, the plurality of reaction chambers extend parallel to the central axis.

In another example of the third aspect and the above examples, the cartridge body further defines an annular space and a plurality of conduits extending from the annular space to the plurality of reaction chamber connectors, each conduit of the plurality of conduits providing a gas path from a reaction chamber of the plurality of reactions chambers to the annular space.

In a further example of the third aspect and the above examples, the cartridge body further defines a plurality of nozzles, each nozzle of the plurality of nozzles connected to a channel of the plurality of channels and extending into an associated reaction chamber of the plurality of reaction chambers. For example, each nozzle of the plurality of nozzles has a tapered interior channel in communication with a channel of the plurality of channels.

In an additional example of the third aspect and the above examples, the cross-sectional area of the plurality of channels is not greater than the cross-sectional area of the input port.

In another example of the third aspect and the above examples, the plurality of channels are configured to provide fluidic resistance to flow of fluid from the input port to the plurality of reaction chambers.

In a further example of the third aspect and the above examples, the plurality of channels are configured to provide back pressure in response to fluid flow from the input port to the plurality of reaction chambers.

In an additional example of the third aspect and the above examples, a volume of the plurality of channels is not greater than 5% of a volume to be received by the plurality of reaction chambers.

In another example of the third aspect and the above examples, the cartridge body further defines an exterior shell.

In a further example of the third aspect and the above examples, the cartridge further includes a reagent disposed in a reaction chamber of the plurality of reaction chambers.

In an additional example of the third aspect and the above examples, the reagent is a lyophilized reagent.

In another example of the third aspect and the above examples, the plurality of reaction chambers include between 2 and 26 reaction chambers.

In a further example of the third aspect and the above examples, the cartridge body further defines a central stem aligned with the central axis to connect to a motor of an instrument. For example, the central stem has a gear cross-section configured to fit a complementary socket. In another example, the cartridge further includes a magnet or ferromagnetic plug disposed in the central stem.

In an additional example of the third aspect and the above examples, the cartridge body further defines flanges in proximity to the input port. For example, the flanges define a male luer connector.

In another example of the third aspect and the above examples, each reaction chamber of the plurality of reaction chambers is transparent in the visible spectrum.

In a further example of the third aspect and the above examples, the cartridge body has a cylindrical configuration. For example, the cartridge body defines a gap in the cylindrical configuration when viewed from a top cross-section.

In a fourth aspect, a method includes injecting a fluid sample into an input port of a cartridge, the cartridge including: a cartridge body defining the input port aligned with a central axis of the cartridge body, a plurality of channels in fluidic communication with the input port and extending radially to a plurality of reaction chamber connectors; and a plurality of reaction chambers disposed at a radial distance from the central axis of the cartridge body and distributed at angles relative to the others of the plurality of reaction chambers, each reaction chamber of the plurality of reaction chambers uniquely connected to a reaction chamber connector of the plurality of reaction chamber connectors, each reaction chamber of the plurality of reaction chambers in fluid communication with the input port via a channel of the plurality of channels, a reaction chamber of the plurality of reaction chambers including a reagent, the fluid distributing to each of the plurality of reaction chambers. The method further includes inserting the cartridge into an instrument including an incubation block, a motor, an illumination source, and an imaging device; rotating the cartridge body with the motor to align a reaction chamber of the plurality of reaction chambers with the illumination source and the imaging device; and photographing the reaction chamber to acquire a photographic image.

In an example of the fourth aspect, the method further includes rotating the cartridge body to align a second reaction chamber of the plurality of reaction chambers with the illumination source and the imaging device, and photographing the second reaction chamber to acquire a second photographic image.

In another example of the fourth aspect and the above examples, the method further includes determining using the photographic image a presence of a genetic material.

In a further example of the fourth aspect and the above examples, the method further includes quantifying using the photographic image an amount of a genetic material.

In an additional example of the fourth aspect and the above examples, the method further includes heating the incubation block. For example, the method further includes maintaining the incubation block at a set temperature.

In another example of the fourth aspect and the above examples, the method further 70. The method of claim 64, further comprising processing the photographic image with a neural network. For example, processing the photographic image with the neural network includes determining a defect category of liquid in the reaction chamber associated with the photographic image. In an example, the defect category is the presence of a bubble, the presence of undesirable light, or an evaporation condition.

In a fifth aspect, a method of calibrating an instrument includes illuminating a reaction chamber of a plurality of reaction chambers distributed at angular distributions around a central axis of a cartridge, the cartridge defining a gap having an absence of reaction chambers in the angular distribution; acquiring an image using an imaging device, the image including a representation of the illuminated reaction chamber; determining a center line of the representation of the illuminated reaction chamber; correlating the determined central line with a physical position of a center of the reaction chamber; and rotating the cartridge to find the gap.

In an example of the fifth aspect, determining the center line includes converting the image to greyscale and finding a mean intensity.

In a sixth aspect, a method of analyzing a sample includes acquiring an image of a reaction chamber in which a reaction produces a colorimetric or fluorescent signal; applying the image to a neural network or multiple neural networks, the neural networks providing categorical results and a defect category associated with the colorimetric or fluorescent signal; processing the image in accordance with the defect category; and determining a result associated with the reaction.

In an example of the sixth aspect, the result is detection of an analyte.

In another example of the sixth aspect and the above examples, the result is quantification of an analyte.

In a further example of the sixth aspect and the above examples, the reaction is a genetic amplification reaction.

In an additional example of the sixth aspect and the above examples, the defect category is the presence of a bubble, the presence of undesirable light, or an evaporation condition.

In a seventh aspect, a method of developing a neural network for categorizing reactions includes acquiring an image of the reaction chamber in which a reaction produces a colorimetric or fluorescent signal; categorizing the image as having a signal, not having a signal, or having a defect state; defining a neural network structure; training the neural network by modifying its parameters in response to performance on a dataset of training images; storing the neural network on an instruments configured to receive the reaction chamber.

In an example of the seventh aspect, the defect state is selected from the group consisting of a bubble, debris, evaporation, asymmetry, and glare.

In another example of the seventh aspect and the above examples, the neural network is trained to provide a category with a statistical confidence.

In a further example of the seventh aspect and the above examples, 83 the neural network is trained to detect an analyte.

In an additional example of the seventh aspect and the above examples, the neural network is trained to quantify an analyte.

In another example of the seventh aspect and the above examples, the reaction is a genetic amplification reaction.

In an eighth aspect, a method of applying a neural network for categorizing reactions includes acquiring an image of the reaction chamber in which a reaction produces a colorimetric or fluorescent signal; processing the image through a neural network or multiple neural networks; using the processed results to categorize the image as a signal type to provide a categorized result; processing the categorized result to determine a result.

In an example of the eighth aspect, the result of processing an image by the neural network is a category with a statistical confidence.

In another example of the eighth aspect and the above examples, the categories may denote positive or negative signals.

In a further example of the eighth aspect and the above examples, the categories may include undetermined signals or error categories for poor signals

In an additional example of the eighth aspect and the above examples, processing includes summing the categorized results and applying a threshold to obtain the result.

In another example of the eighth aspect and the above examples, the categorical results may be selected from a larger assortment of categorical results.

In a further example of the eighth aspect and the above examples, the result for a sample is a category.

In a ninth aspect, a cartridge includes a cartridge body defining a gap in a cylindrical configuration when viewed from a top cross-section; and a plurality of reaction chambers disposed at a radial distance from a central axis of the cartridge body and distributed at angles relative to the others of the plurality of reaction chambers except in the gap.

In an example of the ninth aspect, the plurality of reaction chambers extend parallel to the central axis.

In another example of the ninth aspect and the above examples, the cartridge body further defines an exterior shell.

In a further example of the ninth aspect and the above examples, the cartridge further includes a reagent disposed in a reaction chamber of the plurality of reaction chambers. For example, the reagent is a lyophilized reagent.

In an additional example of the ninth aspect and the above examples, the plurality of reaction chambers include between 2 and 26 reaction chambers.

In another example of the ninth aspect and the above examples, the cartridge body further defines a central stem aligned with the central axis to connect to a motor of an instrument. For example, the central stem has a gear cross-section configured to fit a complementary socket. In an example, the cartridge further includes a magnet or ferromagnetic plug disposed in the central stem.

In a further example of the ninth aspect and the above examples, each reaction chamber of the plurality of reaction chambers is transparent in the visible spectrum.

In an additional example of the ninth aspect and the above examples, the each reaction chamber of the plurality of reaction chambers is detachable.

In another example of the ninth aspect and the above examples, the each reaction chamber of the plurality of reaction chambers is replaceable.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

1. A system comprising:
a cartridge including:
a cartridge body defining an input port aligned with a central axis of the cartridge body, a plurality of channels in fluidic communication with the input port and extending radially to a plurality of reaction chamber connectors; and
a plurality of reaction chambers disposed at a radial distance from the central axis of the cartridge body and distributed at angles relative to the others of the plurality of reaction chambers, each reaction chamber of the plurality of reaction chambers uniquely connected to a reaction chamber connector of the plurality of reaction chamber connectors, each reaction chamber of the plurality of reaction chambers in fluid communication with the input port via a channel of the plurality of channels; and
an instrument including:
an incubation block configured to receive the plurality of reaction chambers;
a motor and socket to connect with the cartridge;
an illumination source having an illumination pathway; and
a camera or optical array sensor disposed in a signal pathway intersecting the illumination pathway;
wherein the motor and socket are to move each reaction chamber of the plurality of reaction chambers into the illumination pathway and the signal pathway, the camera to acquire an image of each reaction chamber, the instrument to determine a result based on the acquired image.

2. The system of claim 1, wherein the imaging device includes a camera.

3. The system of claim 1, wherein the instrument further includes a window disposed along the signal pathway between the imaging device and the intersection of the signal pathway and the illumination pathway.

4. The system of claim 1, wherein the instrument further includes a filter disposed along the signal pathway between the imaging device and the intersection of the signal pathway and the illumination pathway.

5. The system of claim 1, wherein the instrument further includes a user interface.

6. The system of claim 5, wherein the user interface includes a touchscreen.

7. The system of claim 1, wherein the instrument further includes a processor to determine the result utilizing a neural network or multiple neural networks applied to the acquired image.

8. The system of claim 7, wherein the neural network is to determine a defect state associated with the acquired image.

9. The system of claim 1, wherein the instrument further includes a moveable cover configured to enclose the cartridge within the instrument.

10. The system of claim 1, wherein the instrument further includes a thermometer to detect a temperature of the incubation block.

11. The system of claim 1, wherein the instrument further includes control circuitry.

12. The system of claim 1, wherein the plurality of reaction chambers extend parallel to the central axis.

13. The system of claim 1, wherein the cartridge body further defines an annular space and a plurality of conduits extending from the annular space to the plurality of reaction chamber connectors, each conduit of the plurality of conduits providing a gas path from a reaction chamber of the plurality of reactions chambers to the annular space.

14. The system of claim 1, wherein the cartridge body further defines a plurality of nozzles, each nozzle of the plurality of nozzles connected to a channel of the plurality of channels and extending into an associated reaction chamber of the plurality of reaction chambers.

15. The system of claim 14, wherein each nozzle of the plurality of nozzles has a tapered interior channel in communication with a channel of the plurality of channels.

16. The system of claim 1, wherein the cross-sectional area of the plurality of channels is not greater than the cross-sectional area of the input port.

17. The system of claim 1, wherein the plurality of channels are configured to provide fluidic resistance to flow of fluid from the input port to the plurality of reaction chambers.

18. The system of claim 1, wherein the plurality of channels are configured to provide back pressure in response to fluid flow from the input port to the plurality of reaction chambers.

19. The system of claim 1, wherein a volume of the plurality of channels is not greater than 5% of a volume to be received by the plurality of reaction chambers.

20. The system of claim 1, wherein the cartridge body further defines an exterior shell.

21. The system of claim 1, wherein the cartridge further includes a reagent disposed in a reaction chamber of the plurality of reaction chambers.

22. The system of claim 21, wherein the reagent is a lyophilized reagent.

23. The system of claim 1, wherein the plurality of reaction chambers include between 2 and 26 reaction chambers.

24. The system of claim 1, wherein the cartridge body further defines a central stem aligned with the central axis to connect to a motor of an instrument.

25. The system of claim 24, wherein the central stem has a gear cross-section configured to fit a complementary socket.

26. The system of claim 24, wherein the cartridge further includes a magnet or ferromagnetic plug disposed in the central stem.

27. The system of claim 1, wherein the cartridge body further defines flanges in proximity to the input port.

28. The system of claim 27, wherein the flanges define a male luer connector.

29. The system of claim 1, wherein each reaction chamber of the plurality of reaction chambers is transparent in the visible, ultraviolet, or infrared, spectrum.

30. The system of claim 1, wherein the cartridge body has a cylindrical configuration.

31. The system of claim 30, wherein the cartridge body defines a gap in the cylindrical configuration when viewed from a top cross-section.

32.-103. (canceled)
